(19) United States
(12) Patent Application Publication
(10) Pub. No.: US 2014/0160030 A1
(43) Pub. Date: Jun. 12, 2014

(54) SENSOR SYSTEM AND METHOD FOR MAPPING AND CREATING GESTURES

(71) Applicants: David G. Wright, San Diego, CA (US); Ryan Seguine, Seattle, WA (US); Steve Kolokowsky, San Diego, CA (US); David Young, Meridian, ID (US)

(72) Inventors: David G. Wright, San Diego, CA (US); Ryan Seguine, Seattle, WA (US); Steve Kolokowsky, San Diego, CA (US); David Young, Meridian, ID (US)

(73) Assignee: CYPRESS SEMICONDUCTOR CORPORATION, San Jose, CA (US)

(21) Appl. No.: 13/569,048

(22) Filed: Aug. 7, 2012

Related U.S. Application Data
(63) Continuation-in-part of application No. 12/702,930, filed on Feb. 9, 2010.
(60) Provisional application No. 61/150,835, filed on Feb. 9, 2009.

(51) Int. Cl. G09G 5/00

(52) U.S. Cl. 345/173

(57) ABSTRACT

A computing system includes a sensor configured to detect user inputs. The system further includes a processor configured to receive a detected first user input from the sensor. The processor further receives a detected second user input from the sensor. In response, the processor assigns a command to the first user input based on the second user input.

### RELATED APPLICATIONS

This application is a continuation-in-part application of U.S. patent application Ser. No. 12/702,930 filed on Jan. 25, 2011 which claims the benefit of U.S. Provisional Application No. 61/150,835 filed on Feb. 9, 2009, both of which are hereby incorporated by reference herein.

### TECHNICAL FIELD

The present disclosure relates generally to input methods and particularly characteristic detection for sensor devices.

### BACKGROUND

Computing devices, such as notebook computers, personal data assistants (PDAs), kiosks, and mobile handsets, have user interface devices, which are also known as human interface devices (HID). One user interface device that has become more common is a touch-sensor pad (also commonly referred to as a touchpad). A basic notebook computer touch-sensor pad emulates the function of a personal computer (PC) mouse. A touch-sensor pad is typically embedded into a PC notebook for built-in portability. A touch-sensor pad replicates mouse X/Y movement by using two defined axes which contain a collection of sensor elements that detect the position of a conductive object, such as a finger. Mouse right/left button clicks can be replicated by two mechanical buttons, located in the vicinity of the touchpad, or by tapping commands on the touch-sensor pad itself. The touch-sensor pad provides a user interface device for performing such functions as positioning a pointer, or selecting an item on a display. These touch-sensor pads may include multi-dimensional sensor arrays for detecting movement in multiple axes. The sensor array may include a one-dimensional sensor array, detecting movement in one axis. The sensor array may also be two dimensional, detecting movements in two axes.

Another user interface device that has become more common is a touch screen. Touch screens, also known as touchscreens, touch panels, or touchscreen panels are display overlays. The effect of such overlays allows a display to be used as an input device, removing the keyboard and/or the mouse as the primary input device for interacting with the display's content. Such displays can be attached to computers or, as terminals, to networks. There are a number of types of touch screen technologies, such as optical imaging, resistive, surface acoustical wave, capacitive, infrared, dispersive signal, piezoelectric, and strain gauge technologies. Touch screens have become familiar in retail settings, on point-of-sale systems, on ATMs, on mobile handsets, on kiosks, on game consoles, and on PDAs where a stylus is sometimes used to manipulate the graphical user interface (GUI) and to enter data. A user can touch a touch screen or a touch-sensor pad to manipulate data. For example, a user can apply a single touch, by using a finger to press the surface of a touch screen, to select an item from a menu.

### BRIEF DESCRIPTION OF THE DRAWINGS

Embodiments are illustrated by way of example and are not intended to be limited by the figures of the accompanying drawings, in which like references indicate similar elements and in which:

FIG. 1 illustrates a system for detecting contacts and assigning gestures and executing commands according to an embodiment;

FIG. 2 illustrates a workshop GUI for gesture definition according to an embodiment.

FIG. 3 illustrates a control panel GUI for gesture parameterization according to an embodiment;

FIG. 4 illustrates a heads-up display for gesture display according to an embodiment;

FIG. 5 illustrates a method for assigning and maintaining gestures according to an embodiment;

FIG. 6 illustrates a method for executing commands and triggers according to the present invention;

FIG. 7 illustrates method for selecting from a list of possible gestures according to an embodiment;

FIG. 8A illustrates a horizontal slider according to an embodiment;

FIG. 8B illustrates a vertical slider according to an embodiment;

FIG. 8C illustrates a radial slider or control knob according to an embodiment;

FIG. 8D illustrates a plurality of buttons according to an embodiment;

FIG. 8E illustrates a single contact geometric shape according to an embodiment;

FIG. 8F illustrates a two-contact geometric shape according to an embodiment;

FIG. 8G illustrates a three-contact geometric shape according to an embodiment;

FIG. 9A illustrates a compass needle for two contacts for rotate gestures according to an embodiment;

FIG. 9B illustrates a compass needle for two contacts for rotate gestures according to an embodiment;

FIG. 9C illustrates a compass needle for three contacts for rotate gestures according to an embodiment;

FIG. 10A illustrates a move gesture for two contacts according to an embodiment;

FIG. 10B illustrates a move gesture for three contacts according to an embodiment;

FIG. 11A illustrates a expand/contract gesture for two contacts according to an embodiment;

FIG. 11B illustrates a expand/contract gesture for three contacts according to an embodiment;

FIG. 12 illustrates a method for defining and applying gestures to contact locations according to an embodiment;

FIG. 13 illustrates absolute and relative display of movement on a sensor array according to an embodiment;

FIG. 14 illustrates a method for teaching a processor which gestures apply to detected characteristics according to an embodiment;

FIG. 15 illustrates a method for recording gestures according to an embodiment;

FIG. 16 illustrates a touchscreen device for receiving user input according to an embodiment;

FIG. 17 is a block diagram illustrating a computing device for implementing user creatable gestures and gesture mapping, according to an embodiment;

FIG. 18A is a flow diagram illustrating a gesture mapping method, according to an embodiment;

FIG. 18B is a diagram graphically illustrating the gesture mapping method of FIG. 18A;

FIG. 19A is a flow diagram illustrating a gesture mapping method, according to an embodiment;

FIG. 19B is a diagram graphically illustrating the gesture mapping method of FIG. 19A;

FIG. 20A is a flow diagram illustrating a gesture mapping method, according to an embodiment;

FIG. 20B is a diagram graphically illustrating the gesture mapping method of FIG. 20A;

FIG. 20C is a flow diagram illustrating a gesture mapping method, according to an embodiment;

FIG. 20D is a diagram graphically illustrating the gesture mapping method of FIG. 20C;

FIG. 21A is a flow diagram illustrating a method for user creatable gestures, according to an embodiment;

FIG. 21B is a diagram graphically illustrating the gesture mapping method of FIG. 21A;

FIG. 22A is a flow diagram illustrating a method for user creatable gestures, according to an embodiment; and

FIG. 22B is a diagram graphically illustrating the gesture mapping method of FIG. 22A;

### DETAILED DESCRIPTION

In the following description, for purposes of explanation, numerous specific details are set forth in order to provide a thorough understanding of embodiments of the present invention. It will be evident, however, to one skilled in the art that the embodiments may be practiced without these specific details. In other instances, well-known circuits, structures, and techniques are not shown in detail or are shown in block diagram form in order to avoid unnecessarily obscuring an understanding of this description.

Reference in the description to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

A system, method and apparatus are described for detecting a user input on a sensor array and defining and executing commands based on that user input. The commands are defined using a configuration tool and through feedback with either a developer implementing gestures for a user interface or by the user of that interface. A display device for displaying user input, commands and parameters is described as either a stand-alone application or a heads-up display (HUD) visible during typical operation of an operating system.

Gesture detection and detection method development methods and systems are described. Gestures include interactions of an activating element, such as a finger, with an input device that produce an output readable by a controller or processor. Gestures can be single point interactions, such as tapping or double-tapping. Gestures can be prolonged interactions such as motion or scrolling. Gestures can be interactions of a single contact or multiple contacts.

The response of a GUI to user inputs may be defined during development. Developers employ usability studies and interface paradigms to define how a sensing device interprets user input and outputs commands to a host, application processor or operating system. The process for developing and defining gestures and other interactions with a sensing device that cause a feedback event, such as a command to an application or display change, has been hidden to the user of the product. Each gesture may be built from the ground up or constructed from pieced-together lines of code from a library.

Embodiments of the present invention allow for the definition of gestures and other interactions with a GUI through an input device.

A gesture is an end-to-end definition of a contacts interaction with a movement with regard to a sensor array through the execution of a user's intent on a target application or program. The core of a gesture's purpose is to derive semantic meaning and detail from a user and apply that meaning and detail to a displayed target. A “gidget” is a control object which is located in a location relative to a sensor array. A gidget's location may be the entire sensor, such as in a motion gesture, or it may be a specific location or region, such as in buttons activation gestures or scrolling. Gidgets implement metaphoric paradigms for creating and implementing gestures. Metaphoric paradigms represent motions that a user would naturally take in response to and in an effort to control display targets. Such motions include, but are not limited to, rotation, panning, pinching and tapping.

Multiple gidgets can be associated with a sensor array depending on the application specifications. Gidgets are capable of operating independently, each tracking its own state and producing gestures according to its own set of rules. Multiple gidgets are also capable of working in concert to produce gestures based on a combination of cascading rules discussed herein. In either case, single gidgets or multiples of gidgets send control information to targets, such as cursors or menu items, in an application or operating system. To streamline and prioritize the interactions of gidgets where and when they overlap, a hierarchy may be defined to allow top-level gidgets to optionally block inputs to and outputs from low-level gidgets. In an embodiment, low-level gidgets may be buttons and high-level gidgets may be vertical and horizontal sliders. In this embodiment, a motion on the sensor would not activate buttons if the horizontal or vertical slider gidgets are active.

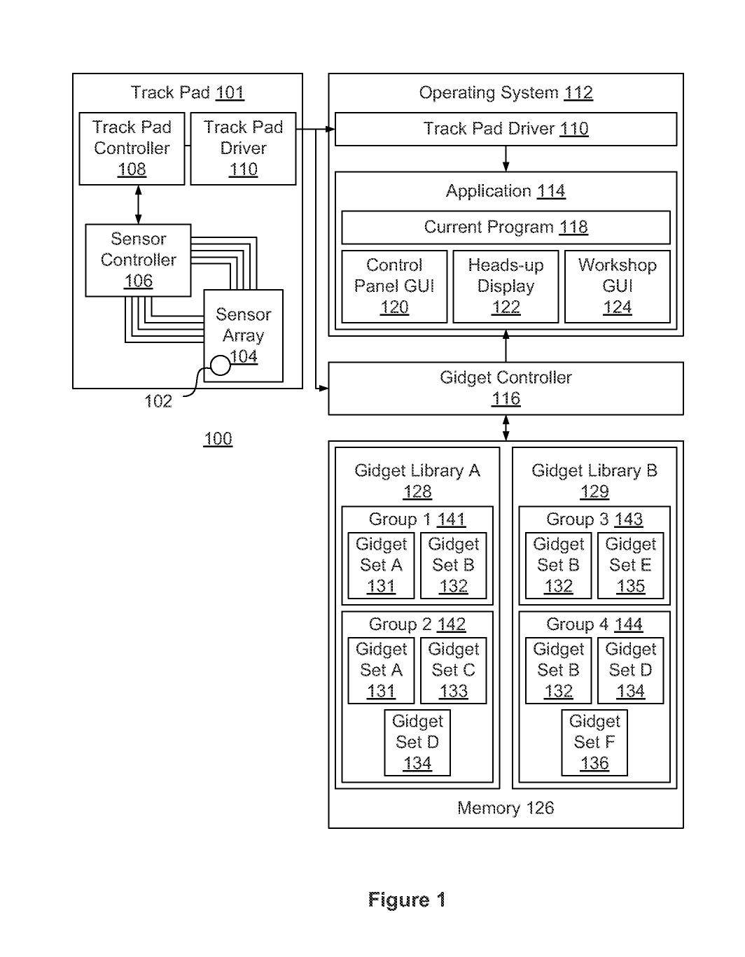

FIG. 1 shows a system 100 for detecting a contact or contacts, interpreting that contact or contacts into a gesture and providing feedback for the definition and development of the gesture detection and interpretation. Contact 102 is detected on sensor array 104 by sensor controller 106. Sensor array 104 may be a capacitive sensor array. Methods for detecting contact 102 on sensor array 104 by sensor controller 106 are described in “Methods and Circuits of Measuring the Mutual and Self Capacitance” Ser. No. 12/395,462, filed 27 Feb. 2009, and “Capacitance To Code Converter With Sigma-Delta Modulator” Ser. No. 11/600,255, filed 14 Nov. 2006, the entire contents of each are incorporated by reference herein. Sensor controller 106 reports contact information, such as capacitance counts for sensor array 104 to track pad controller 108. Track pad controller receives contact information from sensor controller 106 and calculates contact position for each contact. Track pad controller 108 sends contact position information for each contact to operating system 112 through track pad drivers 110A and 110B. Trackpad drivers 110A and 110B communicate position information to application 114 and gidget controller 116.

Application 114 comprises the current program for which the contact interaction with the input sensor array 104 applies. Application 114 may also comprise a control panel GUI 120, a heads-up display (HUD) 122 and a workshop GUI 124, the workshop GUI allows a designer or a user to define gidgets and gidget sets. In one embodiment, the control panel GUI 120, HUD 122 and workshop GUI 124 may be the entirety of the application. In another embodiment, the control panel GUI 120, HUD 122 and workshop GUI 124 may be present alone or in combination in simultaneous operation of a current program 118. Current program 118 may be a photo editing program, a word processing program, a web browsing program or any program for which user interaction is applicable and for which gestures are detected. Gidget controller 116 accesses a memory 126 on which are stored at least one gidget set 131-136. While six gidget sets are shown in FIG. 1, it would be obvious to one of ordinary skill in the art to implement a solution with fewer or more gidget sets based on needs of the system 100. Gidget sets are a collection of definitions for gidgets and of real-time HUD options for HUD 122. Gidget sets 131-136 are assigned to groups 141-144. A group is a category of gidget sets and can be stored in a different memory location or implemented through naming conventions for gidget sets, which is understood by gidget controller 116. While four groups are shown in FIG. 1, it would be obvious to one of ordinary skill in the art to implement a solution with fewer or more group sets based on specifications of the system 100. In one embodiment, three group sets may comprise a total of six gidget sets, with at least three gidget sets in each group.

Groups are assigned to gidget libraries (A and B) 128 and 129. Gidget libraries are folders or memory locations which contain a number of gidget sets that are specific to an application 114 or signed in user. The gidget controller 116 accesses gidgets that are available through a gidget sets 131-136 assigned to groups 141-144, which are contained within a gidget library 128-129. When a different application 114 is opened or a new current program 118 is selected, the gidget controller accesses a different gidget set 131-136 through gidget libraries 128-129 and groups 141-144.

Still referring to FIG. 1, the gidget controller is responsible for a number of tasks including:
monitoring which application window is open or, if no application window is open, detecting the desktop,
implementing new gidget sets 131-136 when a new application window or desktop comes into focus,
driving gidget animations, which display the motion of each gidget as it is detected by the sensor, for the HUD 122,
serializing event target commands toward the application 114 through the operating system 112.
switching HID device driver streams, data streams from the device driver to the host or operating system, “on” and “off,”
configuring a virtual HID such as a mouse, scroll, button, joy-stick and other game control devices, and
injecting HID reports, which summarize the inputs and displays of the HID, into the virtual HID device driver.
   The gidget controller is initiated as a start-up application in the user's application space.

For each gidget, there are associated a number of events. Events relate a gidget's motion or state to an object in the application or operating system with which the user is interacting through the sensor array 102 (FIG. 1). Table 1 lists types of events and their configurable filtering parameters.

TABLE 1
Events and Configurable Parameters

| Event Type | Event | Configurable Parameters |
|---|---|---|
| Linear Motion | Moving | Distance, Speed, Acceleration, |
| (Pixels or Percent | | Assigned Contact Location Count |
| of Range) | Moved | Distance, Average Speed, Max |
| | | Acceleration, Assigned Contact |
| | | Location Count |
| Rotational Motion | Rotating | Distance, Speed, Acceleration, |
| (Degrees or | | Assigned Contact Location Count |
| Relative Measure) | Rotated | Distance, Average Speed, Max |
| | | Acceleration, Assigned Contact |
| | | Location Count |
| Expand/Contract | Expanding | Distance, Speed, Acceleration, |
| Motion (Percent | | Assigned Contact Location Count |
| of Expansion ort | Expanded | Distance, Average Speed, Max |
| Contraction) | | Acceleration, Assigned Contact |
| | | Location Count |
| | Contracting | Distance, Speed, Acceleration, |
| | | Assigned Contact Location Count |
| | Contracting | Distance, Average Speed, Max |
| | | Acceleration, Assigned Contact |
| | | Location Count |
| Tapping Motion | Down | Distance, Speed, Acceleration, |
| (Up Count/Down | | Assigned Contact Location Count |
| Count) | Up | Distance, Average Speed, Max |
| | | Acceleration, Assigned Contact |
| | | Location Count |

Events may be defined in sequences, so that when motion parameters are filtered out for a higher-priority event, subsequent evens in the sequence are not evaluated and do not produce triggers. A trigger is an action that the gidget controller 116 (FIG. 1) applies to an application of operating system. A trigger is stopped when filtering criteria are satisfied.

Event can also be aligned to create a set of overlapping filter requirements and form a series of AND conditions. One embodiment of a set of overlapping filter requirements is an event for “growing” may block lower priority events for “moving” or “rotating” on the same gidget.

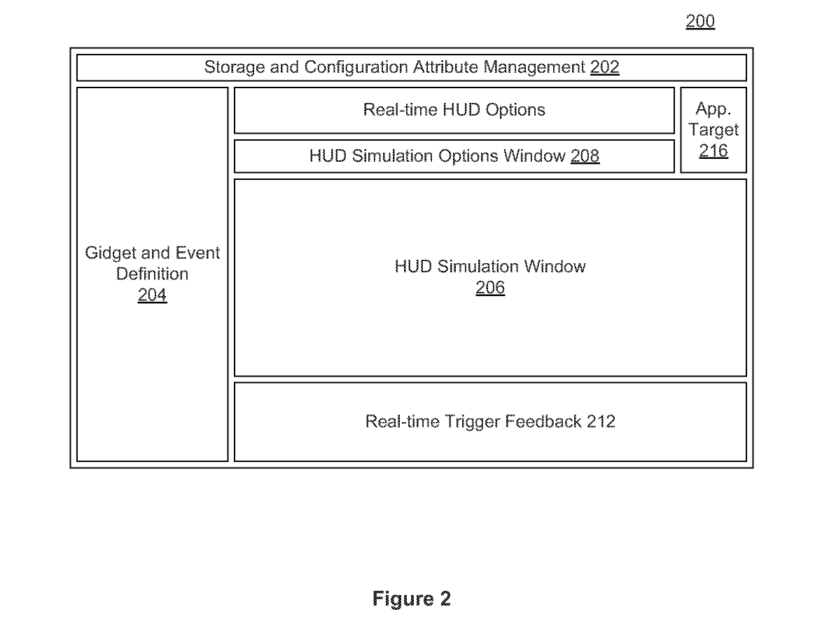

FIG. 2 shows an exemplary layOut for workshop GUI 124 (FIG. 1). The workshop GUI 124 allows a designer or a user to define gidgets and gidget sets. The workshop GUI contains regions for storage and configuration management 202 and gidget and event definition 204. The contact's (102) interaction with sensor array 104 is shown in the HUD simulation window 206, where the contacts are shown as visual representations and indication of the output are also displayed. The HUD simulation window 206 is configured to display characteristics of the contact 102 based on selections in the HUD simulation options window 208. Real-time events and parameters that are visually apparent to the user are displayed and controlled in the real-time HUD options window 210. In an embodiment, real-time events may be contact detection and identification, gesture outputs, or contact location calculation. In another embodiment, parameters that may be visually apparent to the user may be the sensitivity of the sensor or the latency of gesture detection. Triggers for events and gidgets are displayed in the real-time trigger feedback window 212, which displays the detected interactions and how they are interpreted by the gidget controller 116 and displayed in the HUD simulation window 206. Configurations and parameters are written to the gidget controller or the track pad controller through application target 216.

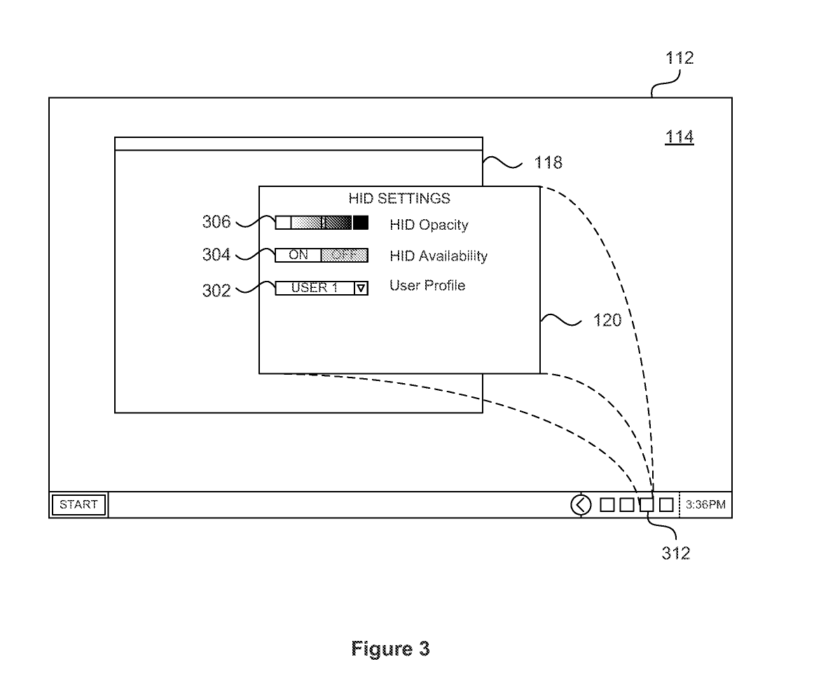

FIG. 3 illustrates an embodiment for the control panel GUI 120. The control panel GUI is accessed during normal operation of the operating system 112, application 114 and/or current program 118. The control panel GUI is accessed by a menu item 312 in the operating system 112 (shown), application 114 or current program 118. The control panel GUI 120 allows a user to select from various personalities or parameter sets 302 for the track pad. The control panel also allows the user to define from among global defaults such as HID availability 304 and HID opacity 306.

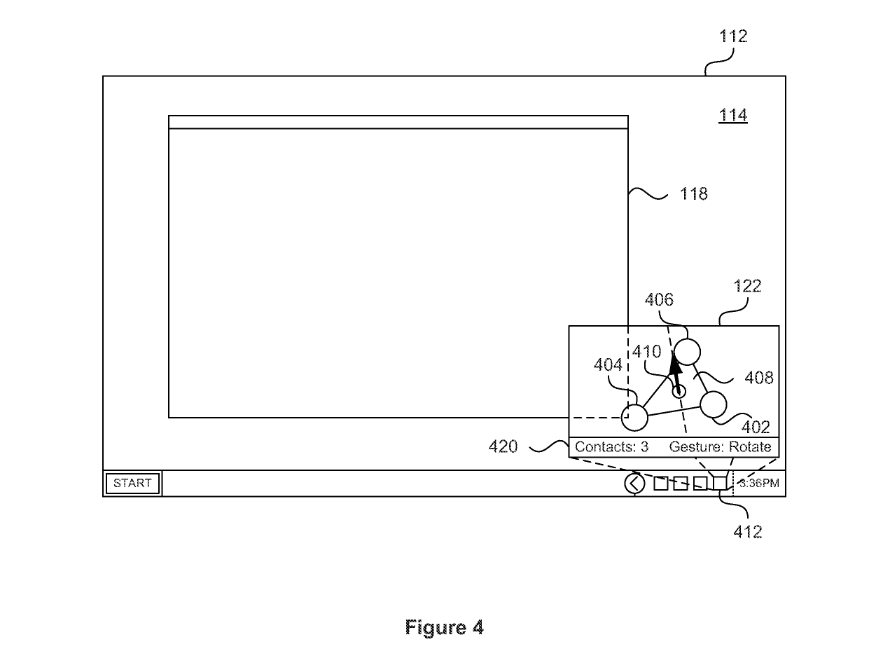

FIG. 4 illustrates an embodiment of HUD 122 of FIG. 1. The HUD 122 is accessed by selecting a menu item 412 in the operating system 112. The HUD 122 is shown in the operating system as a separate window from the application 114 or current program 118. The HUD 122 displays the contacts 402, 404 and 406 as they contact the sensor array 102 of FIG. 1. The HUD 122 shows the shape 408 and center-of-mass defined by the contacts 402, 404 and 406 if possible. That is, a single point of contact will not have shape, only a single location. Two points of contact will define a line, but not a shape. The HUD 122 also illustrates a summary 420 of the interaction. The HUD 122 may be displayed as always on top, always on bottom or some location in between depending on user settings and preferences. The HUD display is configured by the control panel GUI 120 and provides the user and/or the developer with real-time graphical feedback. In one embodiment, the HUD 122 may display individual gidget states which may be displayed as status text, positional read-outs, or a graphical outline. In another embodiment, the HUD 122 may present the location and identification of assigned contact locations. In another embodiment, the HUD 122 may present real-time, scaled gidget animation for use as visual feedback to user interaction with sensor array 102. In yet another embodiment, the HUD may display enlarged animation of gidgets for the sight-impaired, a game player or other experience enhancements, depending on the application. In still another embodiment, the HUD 122 may place a display GUI in a small “corner-of-the-eye” location for visual feedback for standard user input.

In one embodiment, HUD information may be stored in the gidget set to control the opacity of the HUD 122. In another embodiment, the stored information may be the ability of the HUD 122 to flash for a period of time when a new gidget set is activated or be always on or always off. In another embodiment, HUD settings may be set by the user in the control panel GUI 120 as well.

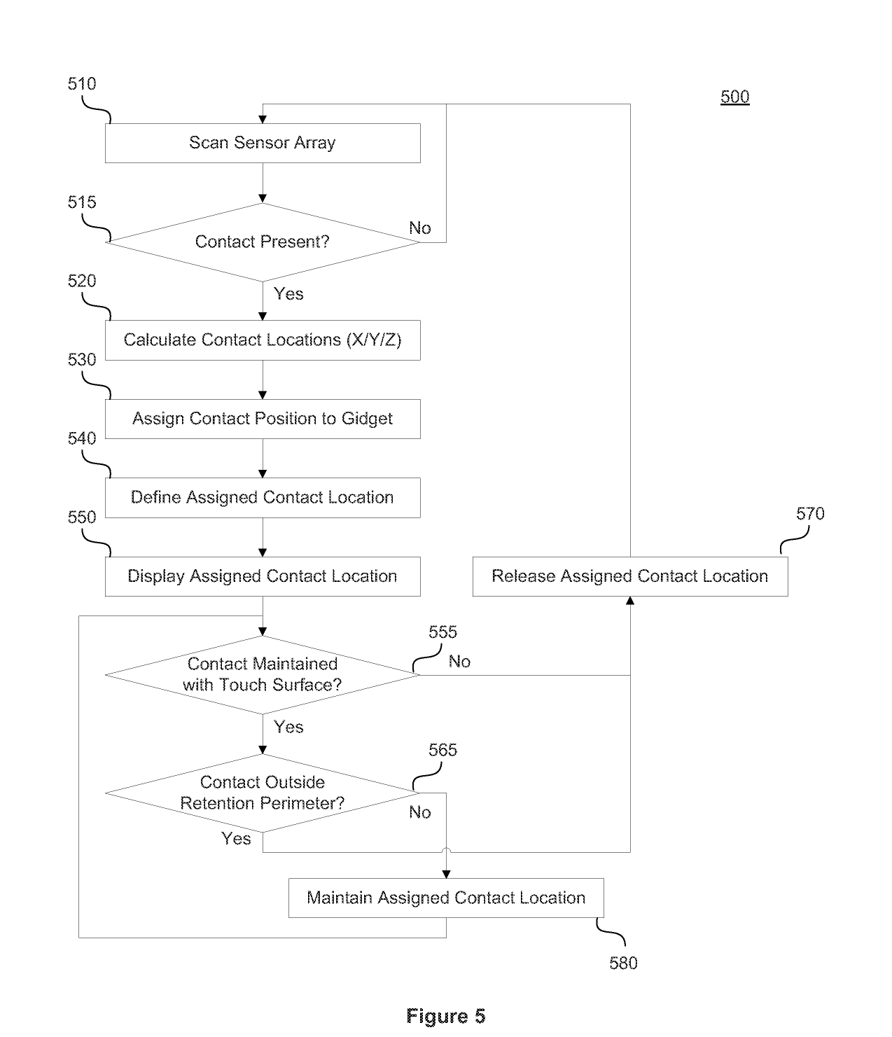

When a gidget has captured and is associated with a contact location (given by X, Y and Z position), it is active. Contact locations assigned to an active gidget are not available to lower-level gidgets when assigned to a higher-level gidget. Higher-level gidgets may access contact locations that are assigned to lower-level gidgets. Contact locations, once captured may be released according to FIG. 5.

FIG. 5 shows a method for assigning and releasing a contact location from an active gidget. The sensor array 102 (FIG. 1) is scanned with sensor controller 104 (FIG. 1) in block 510. Contact presence is detected in decision block 515. If no contact is detected, the sensor is scanned again in block 510. If a contact is detected, the X, Y and Z coordinates of the contact's location are calculated in block 520. If more than one contact is detected, X, Y and Z coordinates of each contact's location are calculated. The contact location or locations are assigned to a gidget in block 530. The assignment of gidgets to contact locations is determined by gidget hierarchy, which may be defined in development or by the user. The combination of a gidget and a contact location defines the assigned contact location in block 540. The defined contact location is displayed in the HUD 122 (FIG. 1) if the HUD 122 is open in block 550. If the contact is not maintained on the sensor array 102 in decision block 555, the assigned contact location is released in block 570 and the associated active gidget is no longer active. If the contact is maintained on the sensor array 102 in decision block 555, the contact's location is compared to a retention perimeter for the active gidget in decision block 565. If the contact location is within the retention perimeter for the active gidget, the assigned contact location is maintained in block 580 and contact detected again to determine if it is still present. If the contact location is outside the retention perimeter for the active gidget, the assigned contact location is released in block 570 and the associated active gidget is no longer active. After release of the contact location, the sensor array is scanned again in block 510.

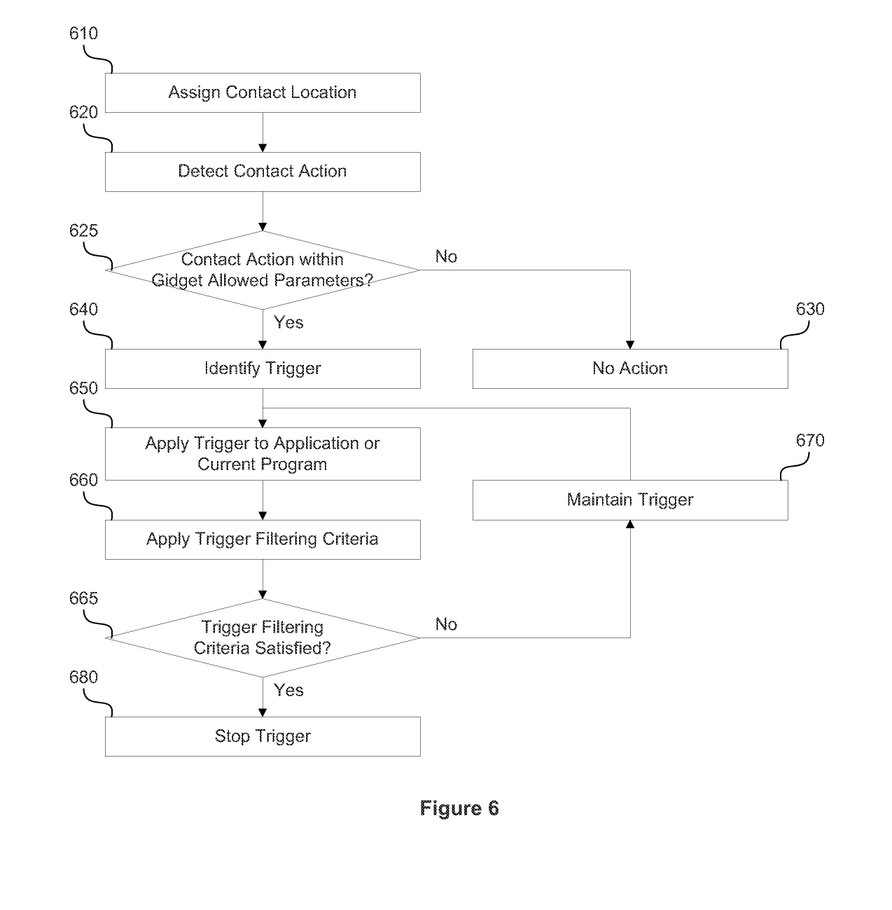

FIG. 6 shows the process for starting and stopping a trigger. A contact location or a plurality of contact locations are assigned to a gidget in block 610. The action, such as movement across the sensor or stationary position in an embodiment, of the contact or contacts is detected in block 620. The contact action is compared to allowable actions for the active gidget for the assigned contact location by the gidget controller 116 (FIG. 1) in decision block 625. If the contact action is outside the allowed parameters for the active gidget, no action is taken in block 630. If the contact action is within the allowed parameters for the active gidget, the appropriate trigger is identified in block 640. The identified trigger is applied to the application 114 (FIG. 1) or current program 118 (FIG. 1) in block 650. Trigger filter criteria are applied in block 660. Trigger filter criteria are specific to the trigger and the active gidget. If the trigger filtering criteria is determined not to be satisfied by the gidget controller 116, the trigger is maintained and continues to be applied to the application 114 or current program 118 in block 650. If the gidget controller determines that the trigger filtering criteria are satisfied, the trigger is stopped in block 680.

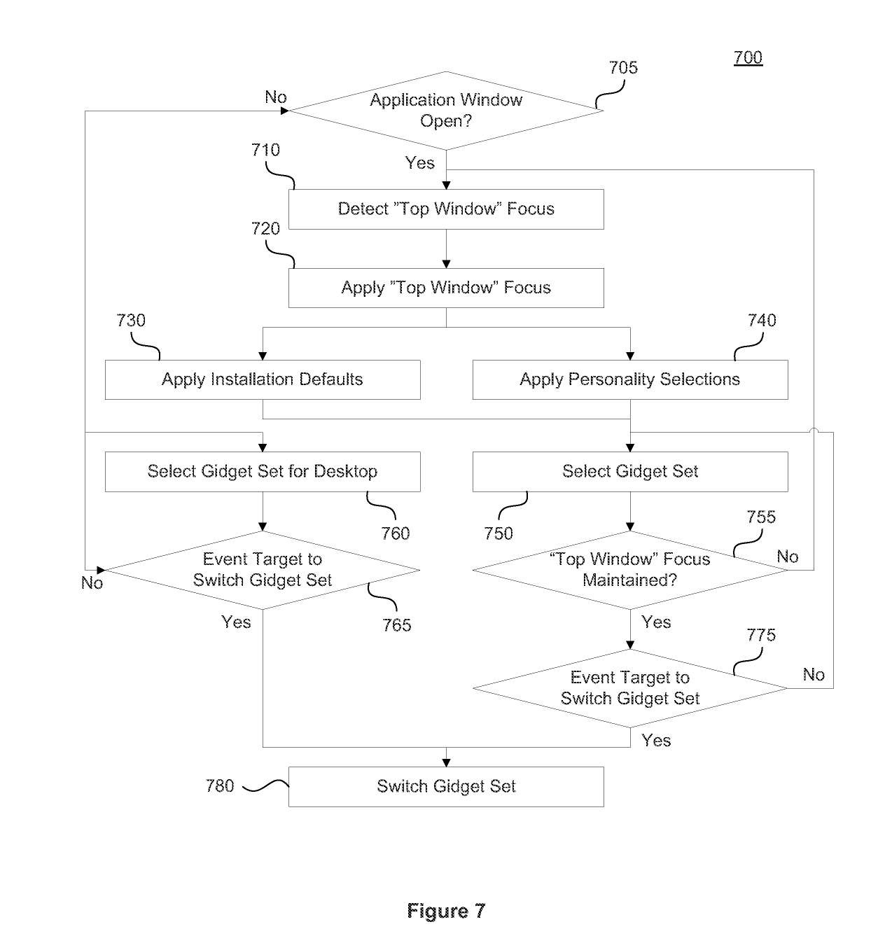

As stated before, events are specific to gidgets. Gidgets can be global or specific to applications. To apply the correct event based on the user interaction with the sensor array 102 (FIG. 1), the process of FIG. 7 is followed. For process 700, an application window detected in decision block 705. If an application window is open, a “Top Window” focus is detected from the application window in block 710. The “Top Window” focus is the open window to which user input is applied. As the user interacts with the system, the “Top Window” focus may change as new applications are opened or windows are activated and deactivated in the display. The “Top Window” focus is applied in block 720. The “Top Window” focus from blocks 710 and 720 may instruct the gidget controller to apply installation defaults in block 730 or it may instruct the gidget controller to apply personality selections in block 740. Personality selections are made in the Control Panel GUI 120 (FIG. 1) and select a gidget set for the interface between the user and the application 114 or current window 118 (FIG. 1). Personality selections may be set for a specific user in one embodiment. In another embodiment, personality selections may be defined for a genre of programs or applications. After installation defaults are applied in block 730 or personality selections are applied in block 740, the gidget set is selected in block 750. The “Top Window” focus maintained or not maintained in decision block 755 by the gidget controller 116 (FIG. 1) based on the selected gidget set from block 750. If the “Top Window” focus is not maintained in decision block 755, a new “Top Window” focus is detected in block 710 again. If the ‘Top Window” focus is maintained in decision block 755, decision block 775 determines if an event target to switch the gidget set is present. If the event target does not specify that the gidget set be switched, the gidget set is set again in block 750. If the gidget controller 116 (FIG. 1) determines that the event target does require the gidget set be switched, the gidget set is switched to the new gidget set in block 780. If, in decision block 705, it is determined that an application window is not open, the gidget set for the desktop or default screen is selected in block 760. Decision block 765 determines if an event target to switch the gidget set is present. If the event target does not specify that the gidget set be switched, the gidget set is set again in block 760. If the gidget controller 116 determines that the event target does require the gidget set be switched, the gidget set is switched to the new gidget set in block 780.

Gidget sets are assembled into gidget libraries as shown in FIG. 1. Gidget libraries define user-targeted solutions for applications. The gidget controller accesses the gidget libraries for the detected application. Gidget libraries may be defined during development or by the user in real-time. The user accesses and assigns gidget libraries through the control panel GUI 120 (FIG. 1). The control panel GUI specifies the preferences in which the selected gidget sets are used (shown in FIG. 7) or turn on and off gidget sets for an application.

A gidget is a control object location on a sensor array. In some embodiments, gidgets may appear as horizontal sliders, vertical sliders, rotational sliders or knobs, buttons, geometric shapes or contact plane. Each gidget type may be defined multiple times. Events capture assigned contact locations for active gidgets subject to a hierarchy and blocking rules. The workshop GUI allows the hierarchy to be rearranged and blocking rules to be redefined according to application requirements.

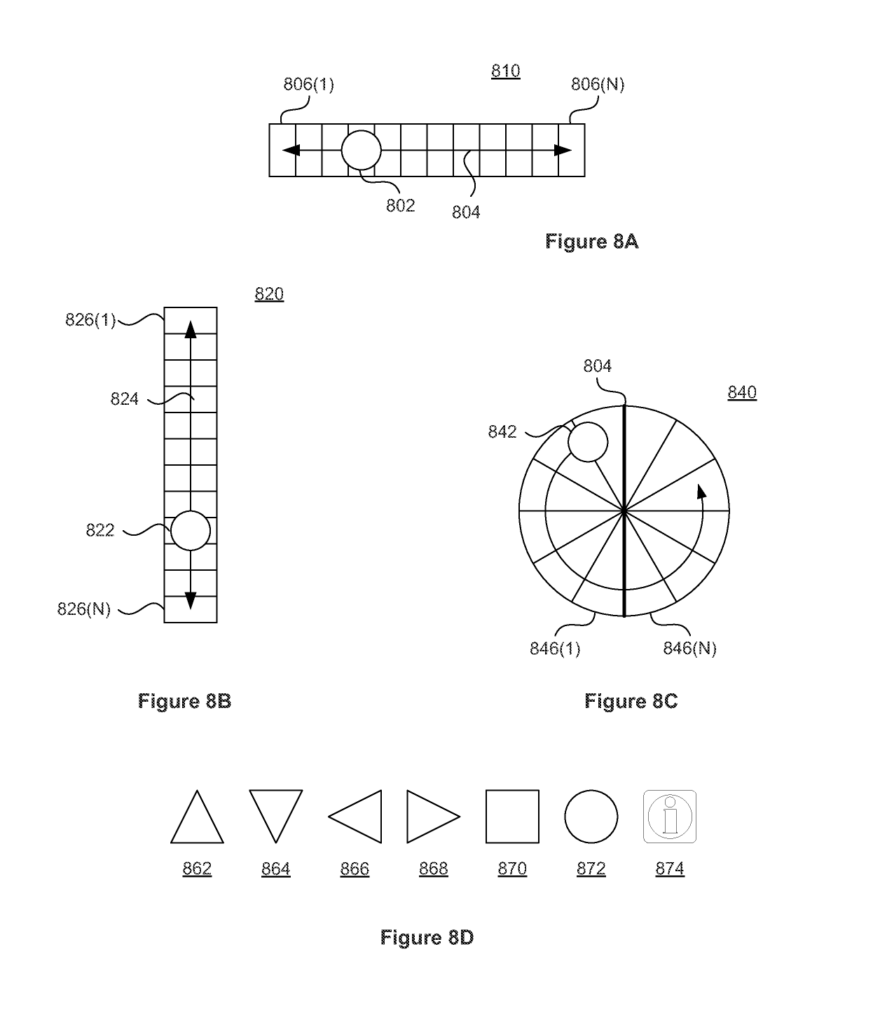

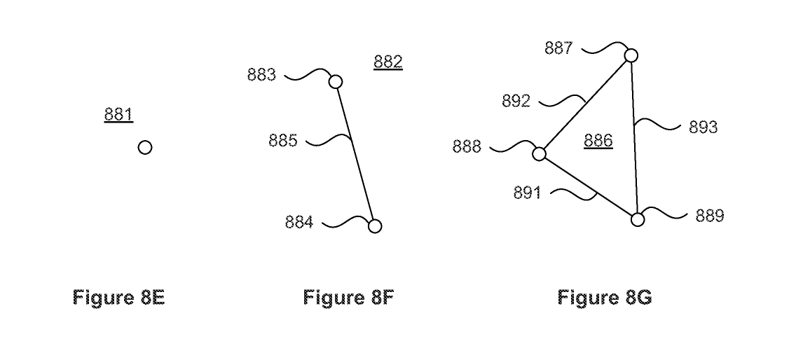

Examples of gidgets are shown in FIGS. 8A-8F. FIG. 8A shows an example of a horizontal slider 800 that may be displayed on HUD 122 (FIG. 1) according to one embodiment. Horizontal slider 810 tracks the position of a contact 802 or a number of contacts in one horizontal dimension 804. Slider elements 806(1) through 806(N) simulate a hardware-based horizontal slider or switch. A horizontal slider gidget may support a number of event types include, but not limited to, moving, moved, expanding, expanded, contracting, contracted, up an down.

FIG. 8B shows an example of a vertical slider 820 that may be displayed on HUD 122 (FIG. 1) according to one embodiment. Vertical slider 820 tracks the position of a contact 822 or a number of contacts in one vertical dimension 824. Slider elements 826(1) through 826(N) simulate a hardware-based horizontal slider or switch. A vertical slider gidget may support a number of event types include, but not limited to, moving, moved, expanding, expanded, contracting, contracted, up an down.

FIG. 8C shows an example of a radial slider (rotational knob) 840 that may be displayed on HUD 122 (FIG. 1) according to one embodiment. Radial slider 840 tracks the position of a contact 842 or a number of contacts in relation to a reference axis. Slider elements 846(1) through 846(N) simulate a hardware-based radial slider or control knob. A radial slider gidget may support a number of event types include, but not limited to, rotating, rotated, up and down.

FIG. 8D shows examples of buttons that may be-used as gidgets according to one embodiment. Button gidgets may include, but are not limited to, up triangle 862, down triangle 864, left triangle 866, right triangle 868, square 870, circle 872 and icon 874. The displayed “icon” button is not representative of the only icon that can be used as an icon button gidget, rather it is shown as an example only. Buttons gidgets may support event types including, but not limited to, up and down.

FIG. 8E shows examples of geometric shape gidgets. Geometric shape gidgets are defined by the number and configuration of contacts. A point gidget 881 is comprised of a single contact. A line gidget 882 is comprised of two contacts, 883 and 884, and the line 885 that connects them. A triangle gidget 886 is comprised of three contacts, 887-889, and the lines 891-893 that connect them. Geometric shape gidgets comprising more than three contacts are defined by those contacts and the non-overlapping connections between them. Geometric shape gidgets may have different events assigned to each configuration based on the number of contacts or other parameters. If no events are assigned to a particular geometric shape gidget, a contact configuration in that the geometric shape may not have an output visible to the user or readable by the application or operating system. In one embodiment, events that are defined for a line gidget but not for a triangle gidget are captured and are displayed in the HUD for two contacts on the sensor array. However, a third contact on the sensor array creates a triangle gidget, which does not have associated events and are not displayed in the HUD. In another embodiment, two geometric gidgets can be defined and assigned events. In such an embodiment and with three contacts present on the sensor array, an active line gidget and an active triangle may be readable by the gidget controller and a line and triangle displayed in the HUD and available or interaction with the application or operating system. A geometric shape gidget may support a number of event types including, but not limited to, rotating, rotated, moving, moved, expanding, expanded, contracting, contracted, up and down.

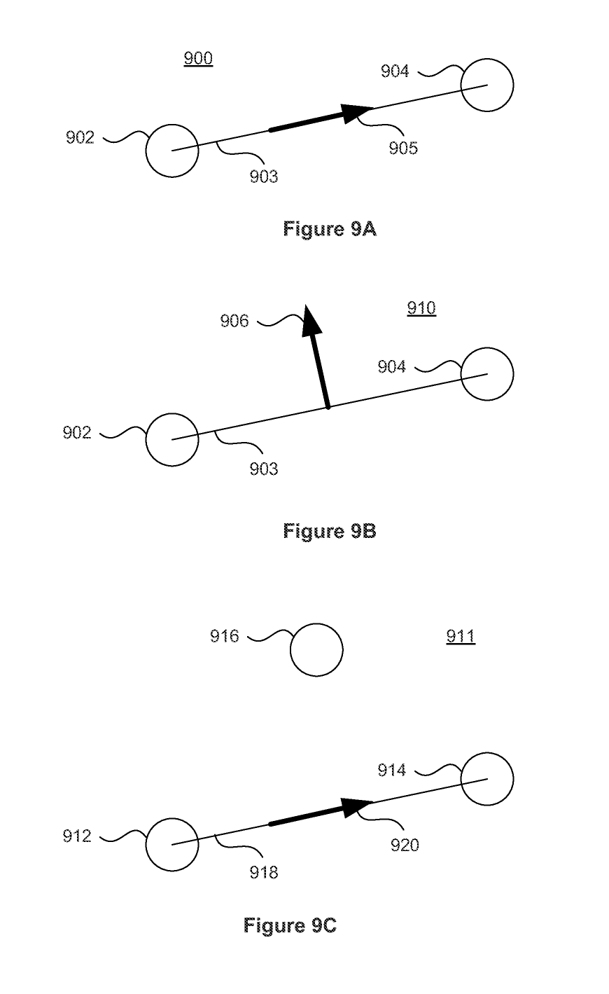

FIGS. 9A-C show how line and triangle geometric shape gidgets are used to execute and display “rotated” and “rotating” events. FIG. 9A shows a first embodiment 900 of two contacts 902 and 904 connected by line 903 and defining compass point 905. Compass point 905 has a direction that is parallel to the line 903 between contacts 902 and 904. As contacts 902 and 904 move and line 903 rotates, compass point 905 also rotates to remain parallel to line 903. Compass point 905 points to the right in FIG. 9A. In on embodiment, the direction of the compass point may be defined by which contact, 902 or 904, is higher. In another embodiment, the direction of the compass point may be defined by which contact, 902 or 904, is in most contact with the sensor.

FIG. 9B shows a second embodiment 910 of contacts 902 and 904 connected by line 903 and defining compass point 906. Compass point 906 has a direction that is perpendicular to the line 903 between contacts 902 and 904. As contacts 902 and 904 move and line 903 rotates, compass point 906 also rotates to remain perpendicular to line 903. Compass point 906 points up in FIG. 9B. In on embodiment, the direction of the compass point 906 may always be positive on detection of multiple contacts. In another embodiment, the direction of the compass point 906 my be defined to point in positive or negative directions based on which contact, 902 or 904 is detected first and where the contacts are relative to each other.

FIG. 9C shows an embodiment of three contacts 912, 914 and 916. In this embodiment, a rotate event is defined by the relative position of the lower two contacts, 912 and 914. The line 918 connecting contacts 912 and 914 is used to define the compass point 920. As contacts 912, 914 and 916 move, line 918 connecting contacts 912 and 914 rotates and compass point 920 also rotates to remaining parallel to line 918. While line and triangle geometric shapes are shown here, it is evident that different geometric shapes may be used to implement rotate and rotating events.

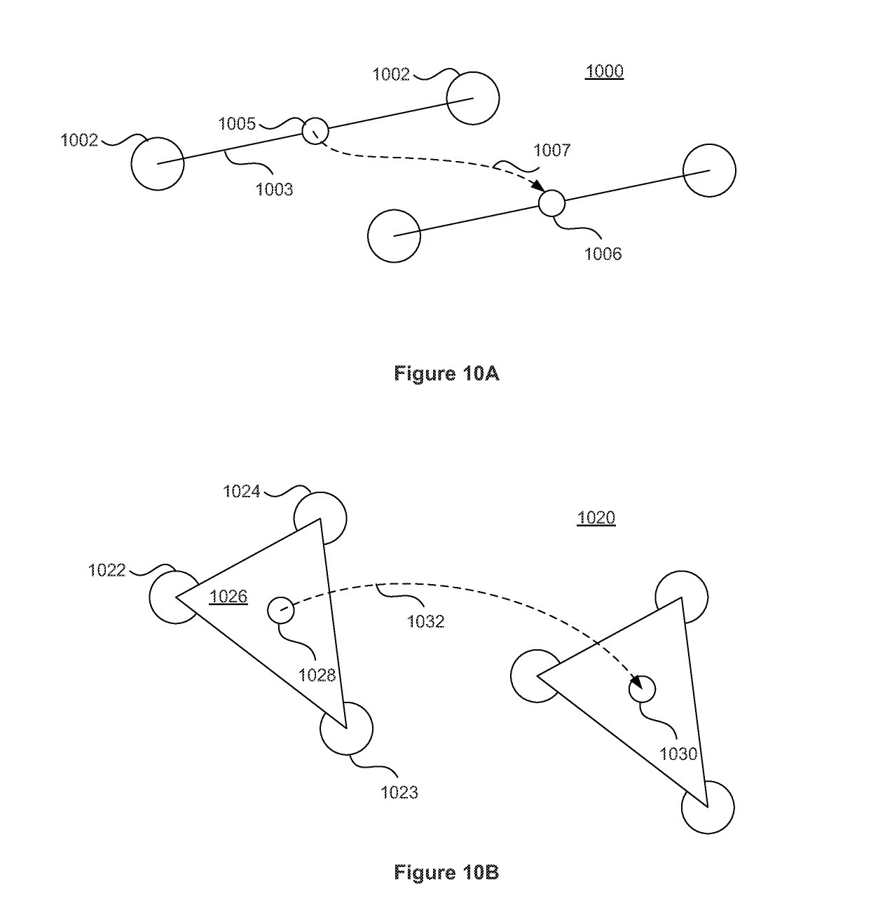

FIGS. 10A and 10B show how line and triangle geometric shape gidgets are used to execute and display “moving” and “moved” events. FIG. 10A shows an embodiment 1000 of two contacts 1002 and 1004 connected by line 1003 and having a center of mass 1005. A moving or moved event is detected by calculating the position of the center of mass 1005 at a first time and comparing that position to the position of the same center of mass at a second time 1006. The path 1007 followed by the center of mass defines the moving or moved event.

FIG. 10B shows an embodiment 1020 of three contacts 1022, 1023 and 1024 which define a shape 1026 having a center of mass 1028. A moving or moved event is detected by calculating the position of the center of mass 1028 at a first time and comparing that position to the position of the same center of mass at a second time 1030. The path 1032 followed by the center of mass defines the moving or moved event. Center of mass 1028 and 1030 are defined by Green's theorem:

$${∮}_{C} ( L d x + M d y ) = \int {\int }_{D} ( \frac{\partial M}{\partial x} - \frac{\partial L}{\partial y} ) d x d y . \qquad Equation 1$$

wherein C is a positively oriented, piecewise smooth, simple closed curve in a plane and D is the region bounded by C. L and M are functions of x and y defined in an open region containing D and have continuous partial derivatives.

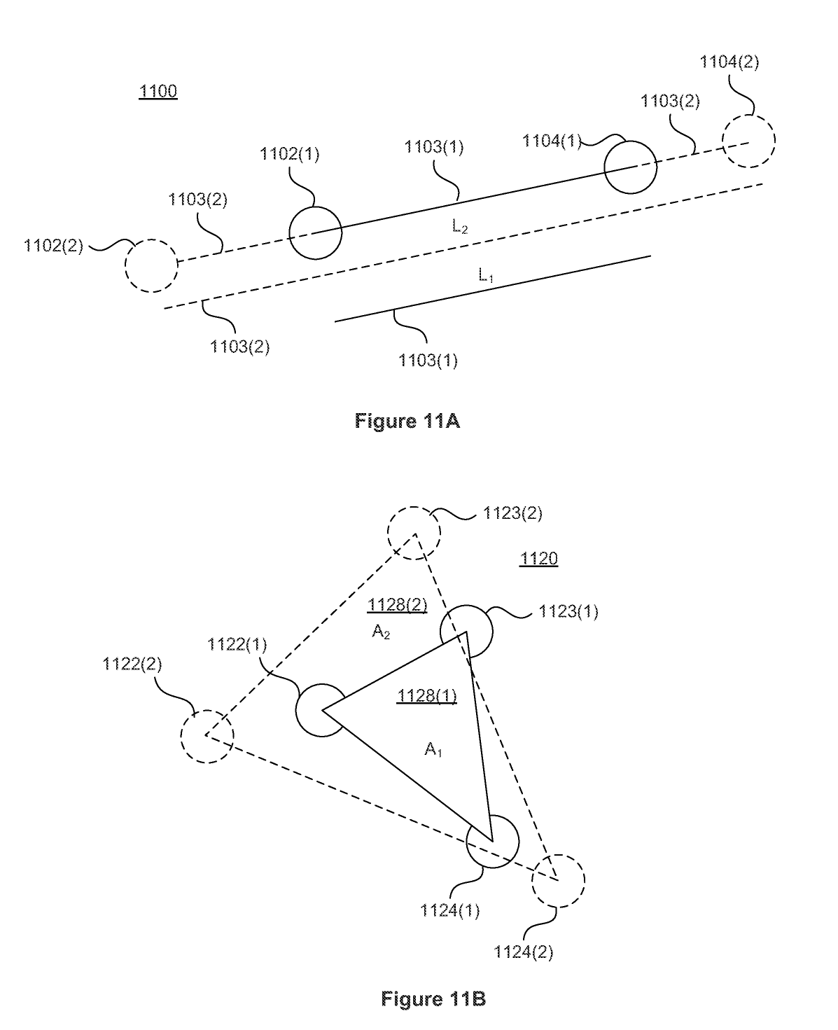

FIGS. 11A and 11B show how line and triangle geometric shape gidgets are used to execute and display “expanding,” “expanded,” “contracting” and contracted” events. FIG. 11A shows an embodiment 1100 of two contacts 1102(1) and 1104(1), which are connected by a line 1103(1) having a length L_{I}. As contacts 1102(1) and 1104(1) move apart, they are shown as contacts 1102(2) and 1104(2) which are connected by line 1103(2) having length L2. The length of line Lᵢ in comparison to line L2 defines the expansion or contraction events. If L_{I} is greater than L2, a contraction event is defined. If L2 is greater than Lᵢ, an expansion event is defined.

FIG. 11B shows an embodiment of three contacts 1122(1), 1124(1) and 1126(1) which define a shape 1128(1) having an area Aᵢ. As contacts 1122(1), 1124(1) and 1126(1) move to new positions shown as contacts 1122(2), 1124(2) and 1126(2), a larger shape 1128(2) having an area A2 is defined. A comparison of A_{I} to A2 defines expansion or contraction events. If A_{I} is greater than A2, a contraction event is defined. If A2 is greater than Aᵢ, an expansion event is defined.

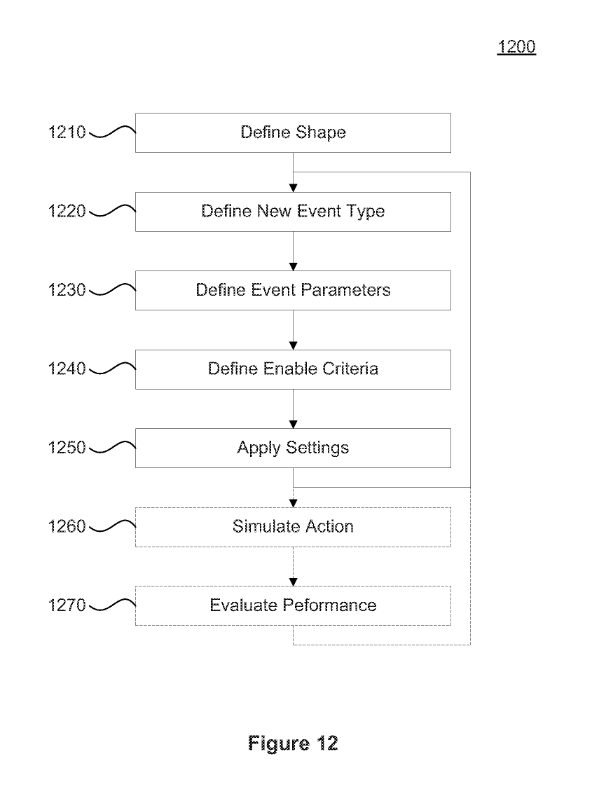

As discussed herein, an event is defined in the workshop GUI 124 (FIG. 1) in the gidget and event definition region 204 (FIG. 2). FIG. 12 shows the process by which an event is defined in the workshop GUI 124. The shape for a geometric shape or a standard gidget is defined in block 1210 by selecting from a list of available gidgets. An event type is defined in block 1220, by selecting form a list of available event types or adding a non-standard event type in an input window. Possible event types may include, but are not limited to, rotating, rotated, moving, moved, expanding, expanded, contracting, contracted, up an down. Event parameters are defined in block 1230 by selecting options for displayed parameters from a list or adding non-standard parameters in an input window according to a set of conventions. Event parameters may include the rate or resolution of rotation, movement and expansion/contraction. Event parameters may also include hysteresis or delay in implementation of the event. Enable criteria are defined in block 1240 by selecting options for enabling the event from a list of possible criteria or by adding a non-standard criterion in an input window according to a set of conventions. Enable criteria define what is necessary for an event to be started and ended. Event type, parameters and enable criteria are then applied to the shape and gidget in block 1250. During development, the action of the gidget may be simulated in block 1260 to ensure that the movement or action detected by the sensor array translates to the desired event. The user or developer is then able to evaluate the performance of the parameters in block 1270, and enable criteria and adjust settings accordingly. In one embodiment, the contacts, gidgets events and triggers are all displayed. The user may see this combination and verify that it is the desired combination. If it is not the desired combination, parameters may be adjusted to change the output combination to meet the specification of the application.

In one embodiment, the position of a contact or contacts on the sensor array is mapped to the display as an absolute position. Gestures that involve cursor control in drawing applications may have the ability for the application to interpret contact or movement of contact over the sensor array without any relative position.

In another embodiment, the position of a contact or contacts on the sensor array is mapped to the display as a relative position on the sensor array and the display device. That is, movement that is 50% across the sensor array will be shown as cursor movement that is 50% across the display device.

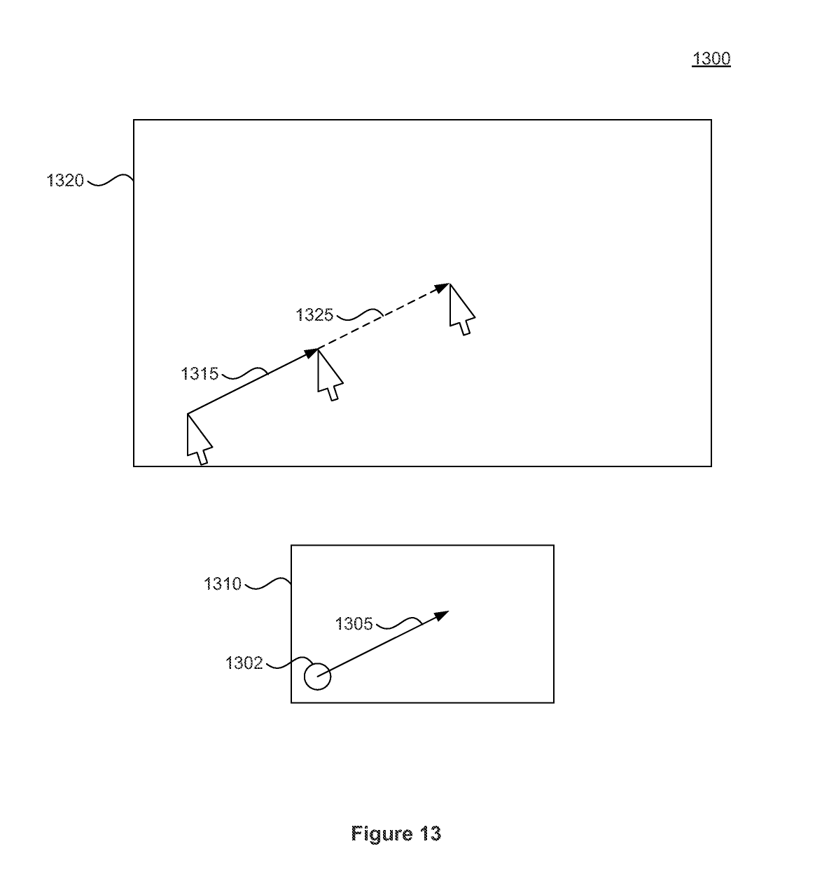

Absolute and relative position is shown in FIG. 13. Contact 1302 moves across the sensor device 1310 along path 1305. This movement is equivalent to approximately 50% of the width of the sensor array. An absolute position for the movement of contact 1302 along path 1305 is shown on display 1320 as path 1315. A relative position for the movement of contact 1302 along path 1305 is shown on display 1320 as path 1325. The relative motion on the display device may be a one-to-one relation in an embodiment, that is, the movement across the sensor device 1310 is directly proportional to the displayed movement on display 1320. In another embodiment, the relative motion on the display device may be a different ratio.

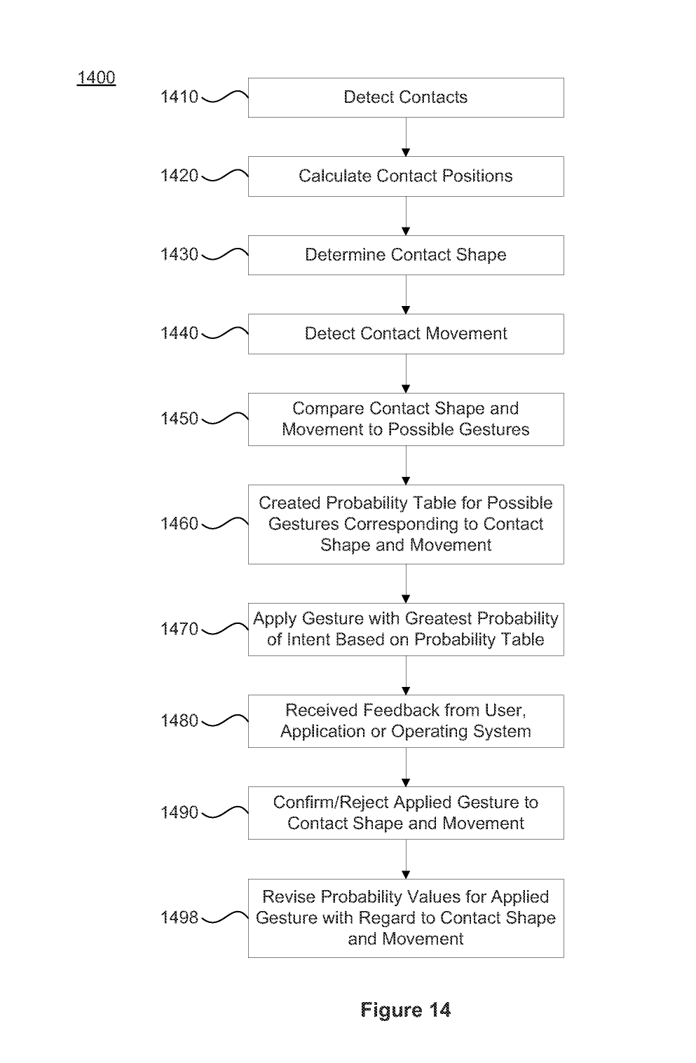

A gesture that is performed by a user may be learned by the gidget controller. One embodiment for gesture learning by the gidget controller is shown in FIG. 14. Contacts are detected on the sensor array in block 1410. In an embodiment, contacts may be detected on the sensory array using a the capacitance measurement circuit configured perform a variety of well-known and understood sensing methods, including charge transfer filtering, relaxation oscillator charging, differential charge sharing between multiple capacitors, and others. In another embodiment, contacts may be detected using non-capacitive sensing methods such as surface-acoustic wave, field effect sensing, or infra-red or other optically-based methods. After contacts have been detected, the position for each contact is calculated in block 1420. There may be only one contact, there may be several contacts. The shape that is defined by the initial placement of the contacts is determined in block 1430 by connecting each contact and comparing the contact arrangement and lines to exemplary arrangements stored in memory 126 (FIG. 1). This shape is then tracked over multiple scans of the sensor array with contacts present to detect movement in block 1440. The contact shape and movement is compared to a list of possible gestures stored in memory 126 in block 1450. In one embodiment, each characteristic of the shape and movement is associated with a probability of a gesture being intended by the user. That is, three contacts may be associated with a rotate more often than four contacts, so a rotate gesture may have a greater probability of selection if there are only three contacts. However the intended gesture for four contacts may be a rotate, so it is computed with a probability. A probability table for all possible gestures for contact shape and movement is created in block 1460. Table 2 shows an example probability table according to one embodiment.

TABLE 2
Example Probability Table

| | Number of Contacts | | | | |
|---|---|---|---|---|---|
| Gesture | 1 | 2 | 3 | 4 | 5 |
| Tap | 73 | 15 | 5 | 1 | |
| Rotate | 1 | 45 | 30 | 31 | 31 |
| Move | 20 | 20 | 35 | 36 | 36 |
| Expand | 1 | 10 | 15 | 16 | 16 |
| Contract | 1 | 10 | 15 | 16 | 16 |

Each gesture is assigned a probability of intent based on the shape and movement of the contacts. For the example probability table shown in Table 2, with three contact detected, a “move” gesture is selected.

The gesture with the greatest probability of intent is selected from the probability table and applied to the application in block 1470. Feedback is received from the user, application or operating system on the applied gesture in block 1480. This feedback could be in the form of an “undo gesture” command, response to a visual or audio prompt to the user, or a lack of response within a timeout period (signifying confirmation of the intended gesture). This feedback may be given in response to a presented gesture that happens when the user pauses on the sensor array or maintains the contacts in proximity to but not in direct contact with the array. Such an action can be referred to as a “hover.” When the contacts hover above the array after a gesture has been performed the probable applied gesture may be presented for approval by the user. The applied gesture is confirmed or rejected based on the feedback from the user, application or operating system in block 1490. The probabilities of each gesture corresponding to the contact shape and movement are updated based on the confirmation or rejection of the applied gesture in block 1498. In one embodiment, confirmation of the applied gesture increases the probability that the applied gesture will be applied again for a similar contact shape and movement, while other gestures' probabilities are reduced. If a gesture is confirmed to be a “rotate” gesture, the a scalar is added to the rotate gesture in the probability table that increases the proportion of actions similar to that which was detected that are interpreted as a “rotate” gesture. In another embodiment, rejection of the applied gesture reduces the probability that the applied gesture will be applied again for a similar contact shape and movement, while other gestures' probabilities are increased. In another embodiment, rejection or verification of the applied gesture that is repeated by the user a number of times set in development may eliminate or permanently confirm the applied gesture, respectively.

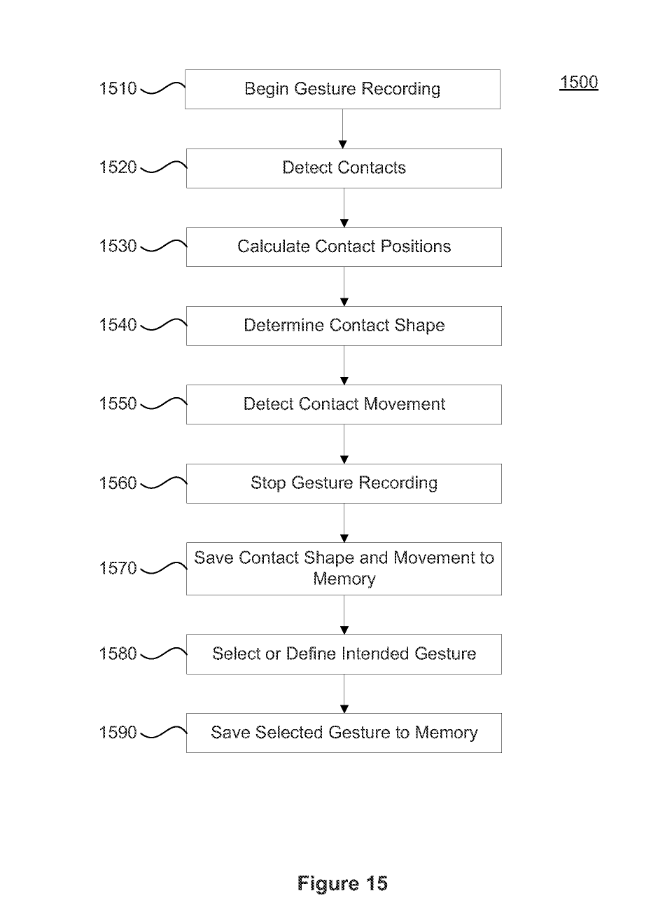

Specific gestures may be defined by the user through specific action. The user may instruct the controller to apply a gesture to specific pattern of contact and movement to create new user- or application-specific gestures. This instruction may be through a “recording” operation. One embodiment for teaching a gesture to the processor is shown in FIG. 15. Gesture recording is begun in block 1510. The start of a gesture recording may be through a radio button, audio command or other GUI item. Contacts are detected on the sensor array in block 1520. Positions for each contact is calculated in block 1530. The shape defined by the contacts is determined in block 1540 and movement of that shape over successive scans of the sensor array is detected in block 1550. Gesture recording is stopped in block 1560. Stopping the gesture recording may be through a radio button, key strike audio command or other GUI item. Contact shape and movement are saved to memory in block 1570. The save contact shape and movement may be displayed for confirmation of intended motion. A list of possible gestures is then presented to the user for selection and application to the saved contact shape and movement and the user selects one of the presented gestures for application to the saved contact shape and movement in block 1580. The list of gestures can be presented while the contacts remain in direct contact with the sensor array or hovering over the sensor array. The selected gesture is then saved to memory in block 1590.

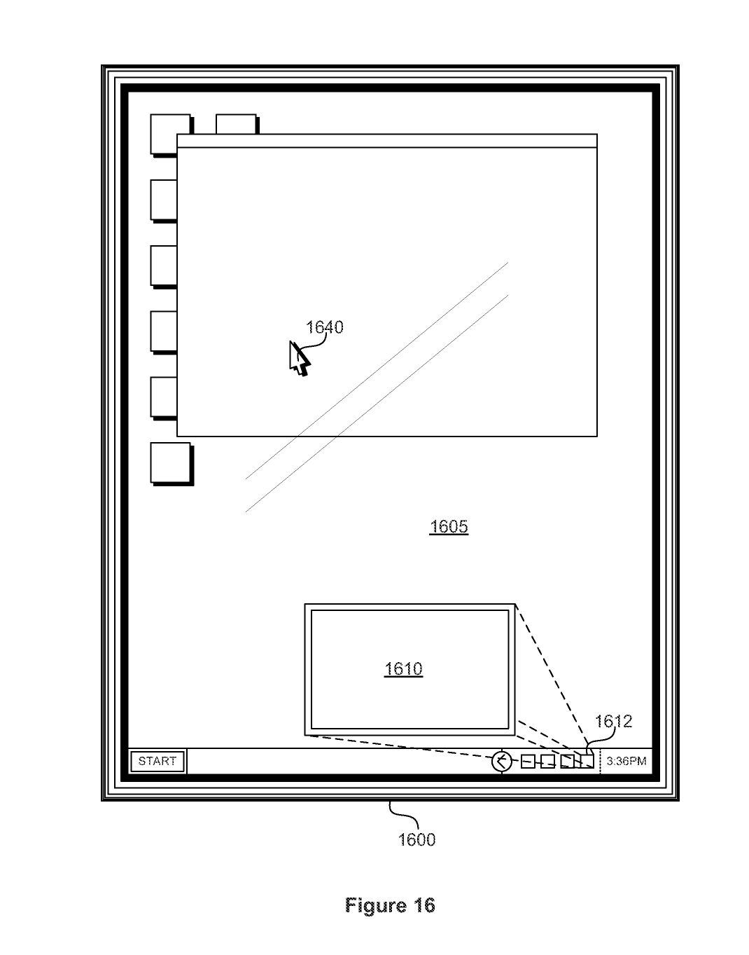

Another embodiment of the present invention is shown in FIG. 16. A touchscreen device 1600, such as a LCD monitor or tablet computer has a touchscreen 1605 for user input. The touchscreen functions as a normal touchscreen, but cursor 1640 control is not through direct input but through a software touchpad 1610 displayed on the touchscreen 1605. The software touchpad 1610 is accessed through menu item 1612 by touching the touchscreen 1605 at the location of menu item 1612.

While gestures in the present application have been described as having only two up to dimensions, the system and methods described could be applied to three-dimension gestures. In such cases contact locations are defined by their X, Y and Z values relative to the sensor array. The addition of a third dimension adds possible gestures and interaction with the user that may not be described here but would be clear to one of ordinary skill in the art to use the described methods for detection and application to the system.

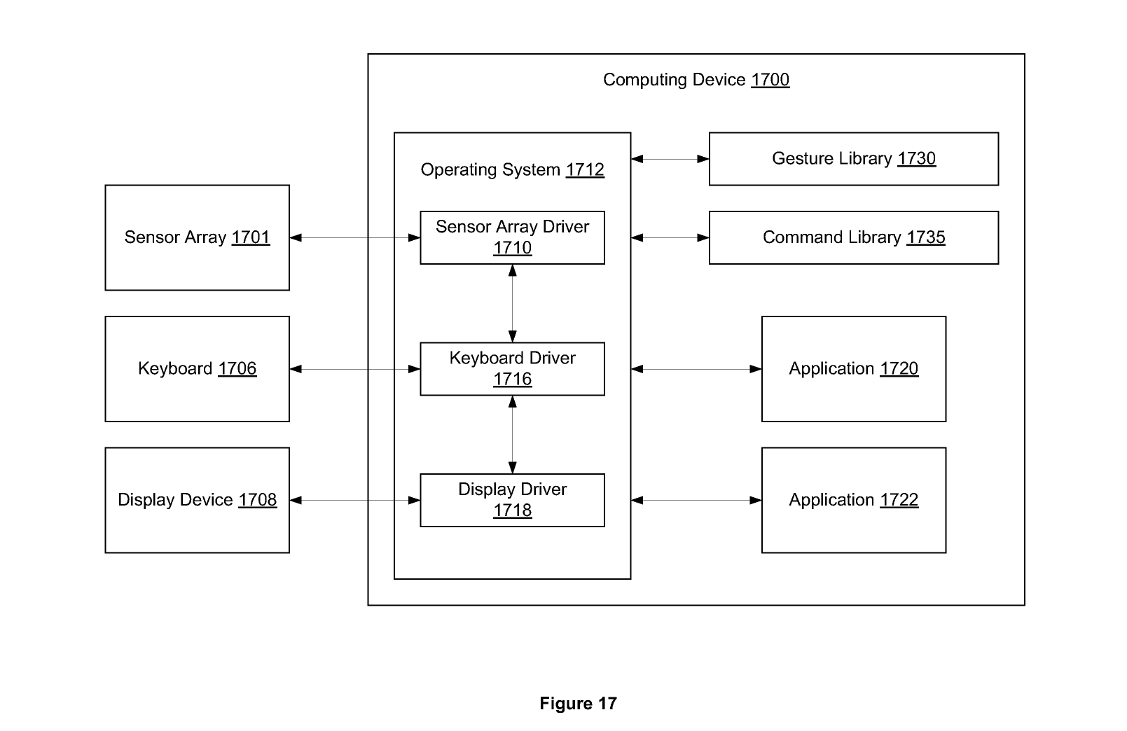

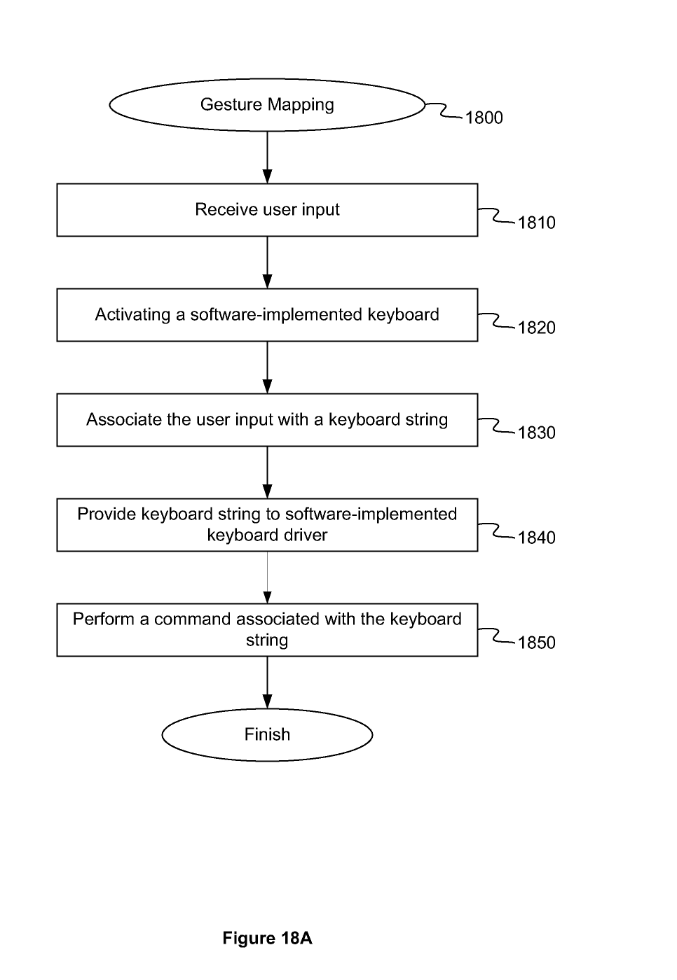

FIG. 17 is a block diagram illustrating a computing device for implementing user creatable gestures and gesture mapping, according to an embodiment of the present invention. In one embodiment, the computing device 1700 is controlled by an operating system 1712. In one embodiment, operating system 1712 may be representative of operating system 112, described above with respect to FIG. 1. Computing device 1700 may further include several computer application programs, such as applications 1720 and 1722. Applications 1720 and 1722 may be representative of application 114, described above with respect to FIG. 1. In addition computing device 1700 may include gesture library 1730 and command library 1735, stored in a memory, such as memory 126. Gesture library 1730 may include a data structure storing characteristics of one or more gestures which may be received by computing device 1700 as user input. The user input may be received by sensor array 1701, which may be representative of track pad 101, described above with respect to FIG. 1. In certain embodiments, sensor array 1701 may include a track pad, touch screen, or other form of input device. The characteristics may include a number of contacts, the position of those contacts, relative and absolute motion of the contacts, etc. Command library 1735 may include a data structure storing a number of commands which may be executed by operating system 1712 or applications 1720 and 1722. The commands in command library 1735 may or may not be mapped to a gesture from gesture library 1730, so that when the gesture is received as a user input, the corresponding command may be executed.

Connected to computing device 1700 may include one or more peripheral devices, such as sensor array 1701, keyboard 1706 and display device 1708. In one embodiment some or all of these devices may be externally connected to computing device 1700, however, in other embodiments, some or all may be integrated internally with computing device 1700. Operating system 1712 of computing device 1700 may include drivers corresponding to each peripheral, including sensor array driver 1710, keyboard driver 1716 and display driver 1718. For example, a user input may be received at sensor array 1701. Sensor array driver 1710 may interpret a number of characteristics of the user input to identify a gesture from gesture library 1730. Sensor array driver 1710 may also determine if the identified gesture corresponds to a command from command library 1735 and may send a signal to an application 1720, causing application 1720 to execute the command.

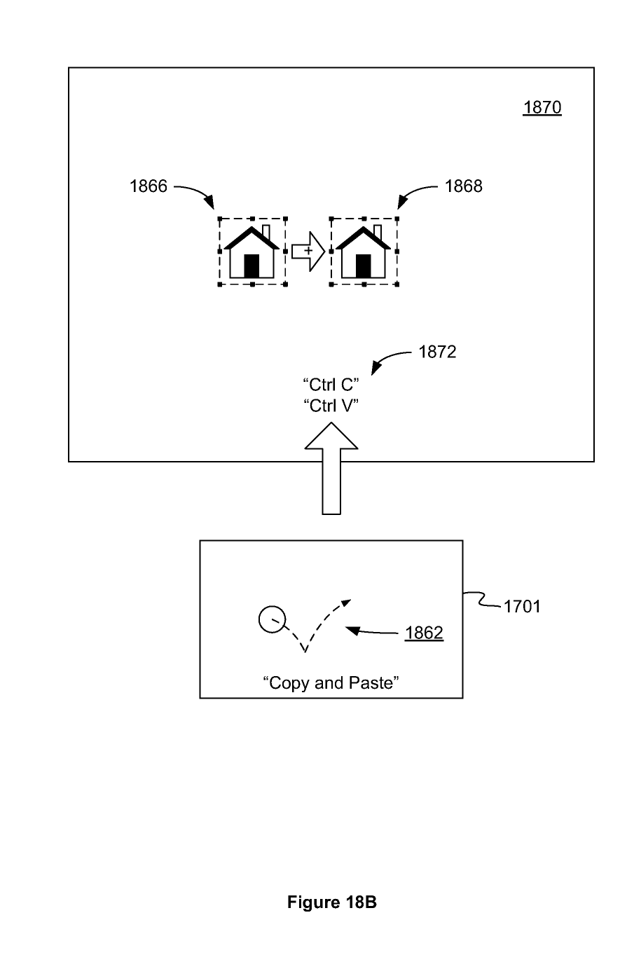

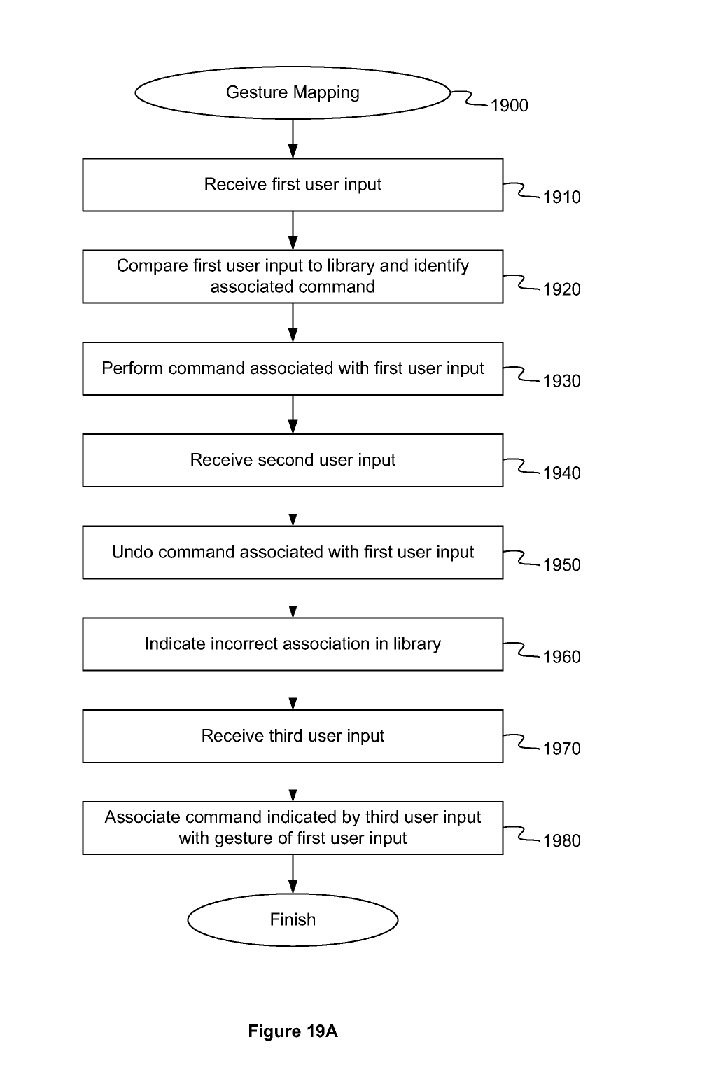

FIG. 18A is a flow diagram illustrating a gesture mapping method, according to an embodiment of the present invention. The method 1800 may be performed by processing logic that comprises hardware (e.g., circuitry, dedicated logic, programmable logic, microcode, etc.), software (e.g., instructions run on a processing device to perform hardware simulation), or a combination thereof. The processing logic is configured to provide a method for gesture mapping to allow mapping of a received input gesture to a command to be performed by a computer application program. In one embodiment, method 1800 may be performed by computing device 1700, as shown in FIG. 17. FIG. 18B is a diagram graphically illustrating the gesture mapping method 1800 of FIG. 18A.

Referring to FIG. 18A, at block 1810, method 1800 receives a user input. In one embodiment, the user input may include a gesture performed by a user on an input device, such as sensor array 1701. The gesture may be identified by a number of characteristics stored, for example, in an entry in gesture library 1730 corresponding to the gesture. The received gesture may be associated with one or more commands stored, for example, in command library 1735. The commands may include operations to be performed by operating system 1712 or applications 1720 and 1722. For example, as illustrated in FIG. 18B, the user input 1862 may include a gesture such as one or more fingers being swiped across the sensor array 1701 to form the shape of a “check mark” or the letter “V.” In one embodiment, this gesture may be associated with an “copy and paste” command that makes a copy of a previously selected object 1864 displayed by an application or the operating system and pastes 1866 the copy of the object into the displayed workspace 1870.

At block 1820, method 1800 activates a software-implemented keyboard. In one embodiment, the software-implemented keyboard may be a logical representation of physical or touch-screen keyboard 1706. The software-implemented keyboard may be stored in a memory of computing device 1700 and used to generate keyboard strings associated with various commands. In one implementation the software-implemented keyboard may comprise a filter driver configured to generate data inputs to the operating system (in response to a request from the gesture processing software) which are functionally equivalent to the data inputs created when a user. At block 1830, method 1800 may identify a corresponding command (e.g., from command library 1735) and associate the received user input 1862 with a keyboard string 1872 for the corresponding command. The keyboard string 1872 may include, for example, a sequence of one or more characters or function keys which may normally be entered by a user in a keyboard 1706. In the example mentioned above with respect to FIG. 18B, where the identified command was the “copy and paste” command, there may be an associated keyboard string 1872. In one embodiment, the keyboard string may include the sequence of pressing the control (“CTRL”) key and the letter “C” followed by the control key again and the letter “V”. Thus, method 1800 may associate the “check mark” gesture with the keyboard string “CTRL C CTRL V” 1872.

At block 1840, method 1800 provides the keyboard string 1872 to the software-implemented keyboard driver. In one embodiment, this may be the same driver as keyboard driver 1716, however in other embodiments, it may be a separate driver. At block 1850, method 1800 instructs the operating system to perform the command associated with the keyboard string. In one embodiment, computing device 1700 may enter the keyboard string (e.g., “CTRL C CTRL V”) using the software-implemented keyboard generated at block 1820. The entry of the keyboard string 1872 may cause a signal to be sent to operating system 1712 or applications 1720 and 1722 which may cause the corresponding command (e.g., the copy and paste command) to be executed or performed by the operating system 1712 or applications 1720 and 1722. As a result a selected object 1866 may be copied and pasted 1868 into the displayed workspace 1870 or other location. In another embodiment, the operating system 1712 may provide features making the software-implemented keyboard unnecessary. For example, sensor array driver 1710 may identify a received gesture 1862 and determine a command associated with that gesture. Sensor array driver 1710 may provide a signal to operating system 1712 or applications 1720, 1722 indicating that the associated command should be performed without entering a keyboard string 1872 using a software-implemented keyboard.

In another embodiment, the commands associated with different gestures may be dependent upon the context in which they are received. Depending on whether an application is currently active or whether only the operating system is running, or which of several different applications are active, certain gestures may be recognized and those gestures may have different associated commands. For example, the “check mark” gesture may only be recognized by certain application such as, applications 1720 and 1722, however operating system 1712 may not recognize the gesture if no applications are running. In addition, the “check mark” gesture may be associated with the “copy and paste” command when performed in application 1720, however, in application 1722, the gesture may have some other associated command (e.g., an undo command). Thus, the gesture library 1730 and command library 1735 may have a context indication associated with certain entries and or may be divided into context-specific sections. In other embodiments, other factors may be considered to identify the proper context for a gesture, such as an identity of the user or a location of the gesture on the sensor array 1701.

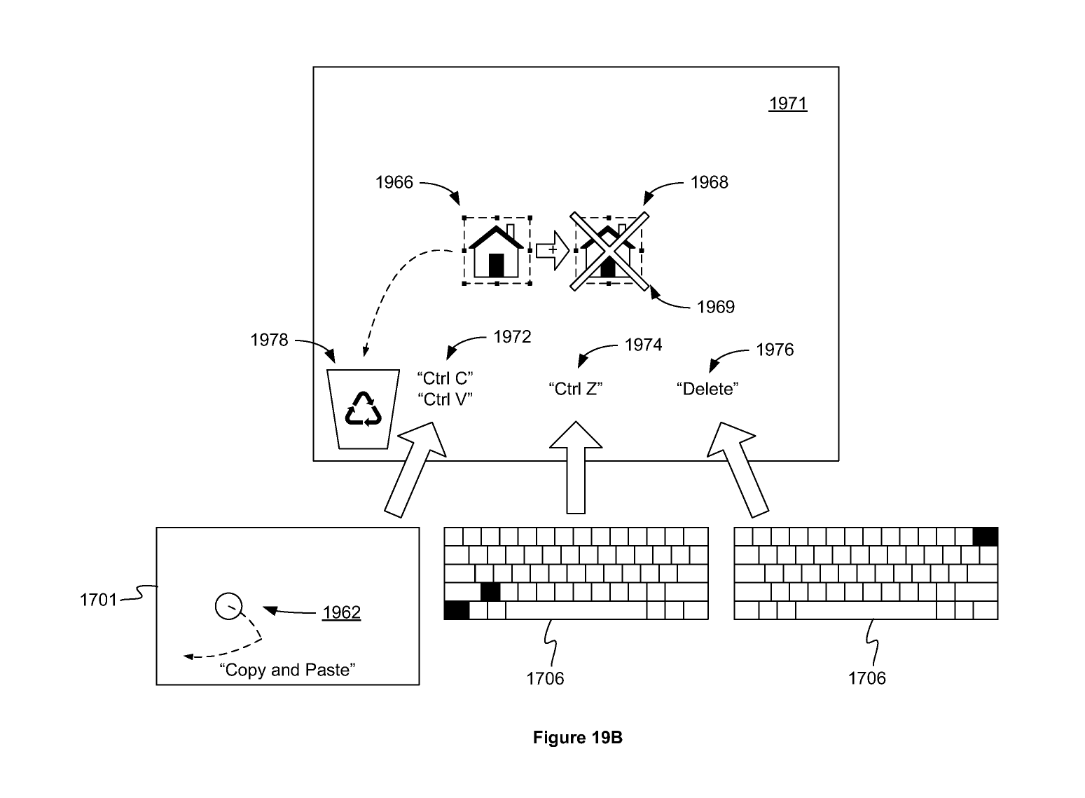

FIG. 19A is a flow diagram illustrating a gesture mapping method, according to an embodiment of the present invention. The method 1900 may be performed by processing logic that comprises hardware (e.g., circuitry, dedicated logic, programmable logic, microcode, etc.), software (e.g., instructions run on a processing device to perform hardware simulation), or a combination thereof. The processing logic is configured to provide method for gesture mapping to associate a command with a received input gesture. In one embodiment, method 1900 may be performed by computing device 1700, as shown in FIG. 17. FIG. 19B is a diagram graphically illustrating the gesture mapping method 1900 of FIG. 19A.

Referring to FIG. 19A, at block 1910, method 1900 receives a first user input. In one embodiment, the first user input may include a gesture performed by a user on an input device, such as sensor array 1701. For example, as illustrated in FIG. 19B, the gesture 1962 performed on sensor array 1701 may include a “back and forth” swipe with one or more fingers. The gesture 1962 may be identified by a number of characteristics stored, for example, in an entry in gesture library 1730 corresponding to the gesture. At block 1920, method 1900 compares the first user input to one or more entries in command library 1735. The received gesture 1962 may be associated with one or more commands stored, for example, in command library 1735. The commands may include operations to be performed by operating system 1712 or applications 1720 and 1722. Sensor array driver 1710 may identify a command associated with the received gesture from command library 1735 and at block 1930, method 1900 may perform the command associated with the first user input. For example, the gesture 1962 may be interpreted as the “copy and paste” command and the keyboard string “CTRL C CTRL V” 1972 may be entered. Performing the command may result, for example, in the execution of an action or function within operating system 1712 or applications 1720 and 1722. For example, a selected object 1966 may be copied and pasted 1968 into the displayed workspace 1971 or other location.

At block 1940, method 1900 receives a second user input. In certain embodiments, the second user input may include, for example, the same or a different gesture received at sensor array 1701, a keystroke or keyboard string received at keyboard 1706, the selection of an item in a user interface, such as an interface presented on display device 1708, or some other form of user input. In one embodiment, the second user input may be any indication that the command performed at block 1930 was not the command that the user intended or desired to be performed. For example, the second user input may include the keyboard string “CTRL Z” (which may implement an “undo” function) 1974, which may be entered by the user on keyboard 1706.

At block 1950, method 1900 may undo 1969 the command associated with the first user input that was performed at block 1930. In one embodiment, the operating system 1712 or application 1720 in which the command was performed may revert back to a state prior to the command being performed. In the example illustrated in FIG. 19B, undoing the command 1969 may include removing the pasted copy 1968 of the selected object 1966. At block 1960, method 1900 may indicate the incorrect or outdated association of the command with the first user input in the command library 1735. For example, sensor array driver 1710 may flag the entry in command library 1735 that associates a certain command with the gesture received as the first user input, remove the association, increment or decrement a counter, or otherwise indicate that the given command should not (or is less likely to) be performed in response to the received gesture in the future.

At block 1970, method 1900 receives a third user input indicating an intended or desired command to be associated with the first user input. The third user input may include, for example, a keystroke or keyboard string 1976 received at keyboard 1706, the selection of an item in a user interface, such as an interface presented on display device 1708, or some other form of user input. The third user input may actually perform the desired command or may indicate the desired command. In one embodiment, the keystroke 1976 may include the “Delete” key. The desired command may include placing the selected object 1966 in the Recycle Bin 1978 or Trash Can. At block 1980, method 1900 associates the command indicated by the third user input (i.e., the “Delete” key) at block 1970 with the gesture 1962 of the first user input received at block 1910. This may include, for example, linking an entry in gesture library 1730 with an entry in command library 1735 for the desired command, or otherwise associating the gesture and command. Thus, in the future, when the gesture 1962 is received as user input, the newly associated command (i.e., placing the object in the Recycle Bin) may be performed in response.

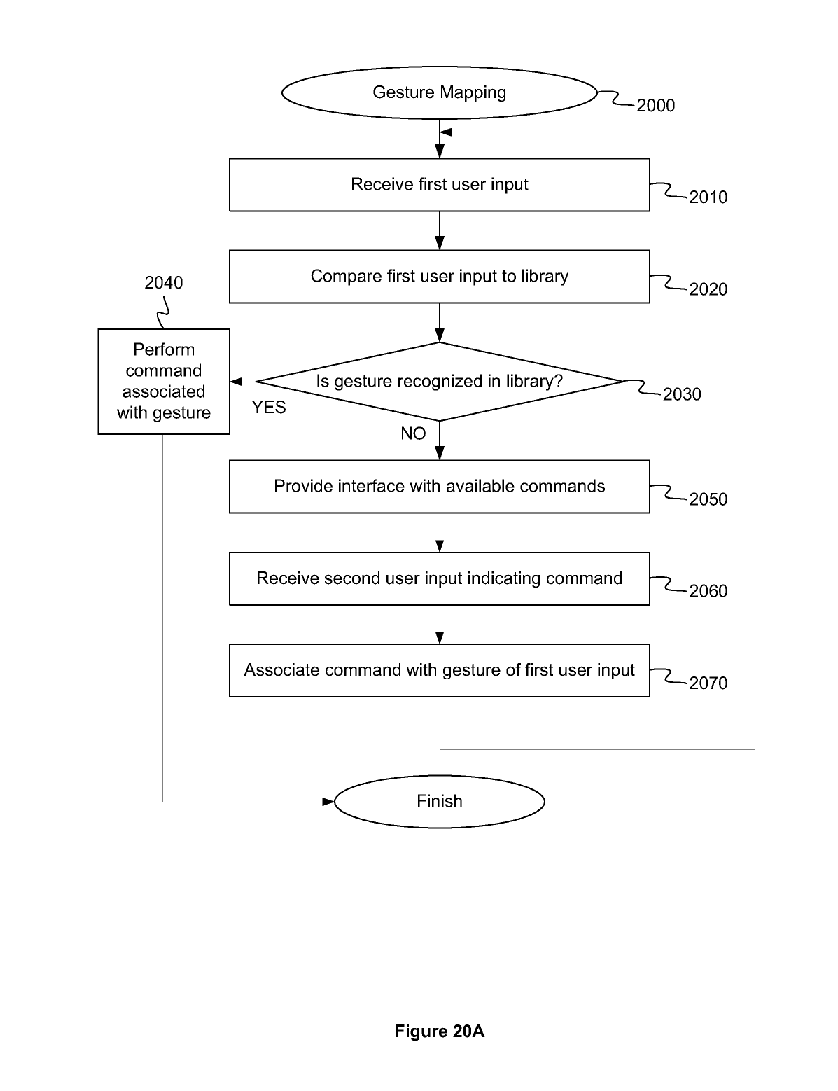

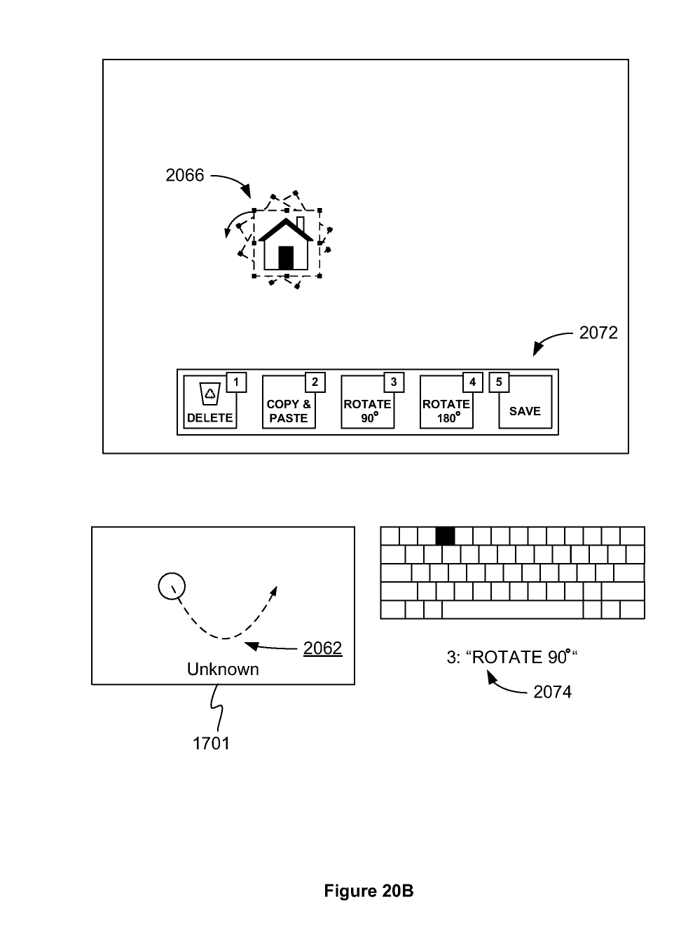

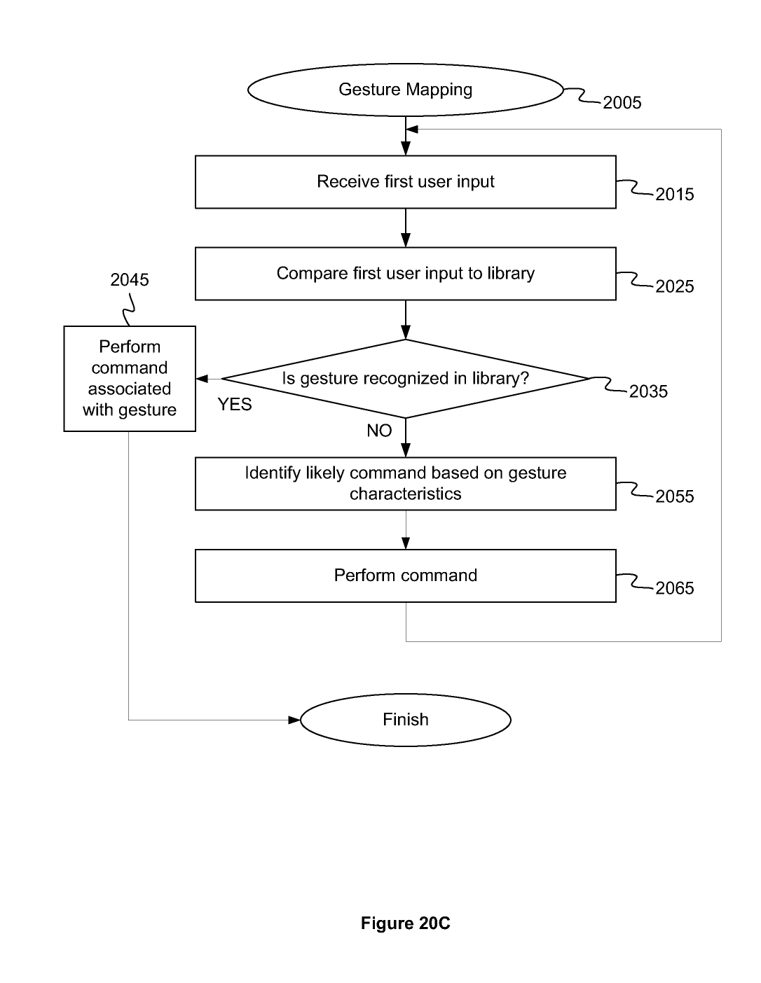

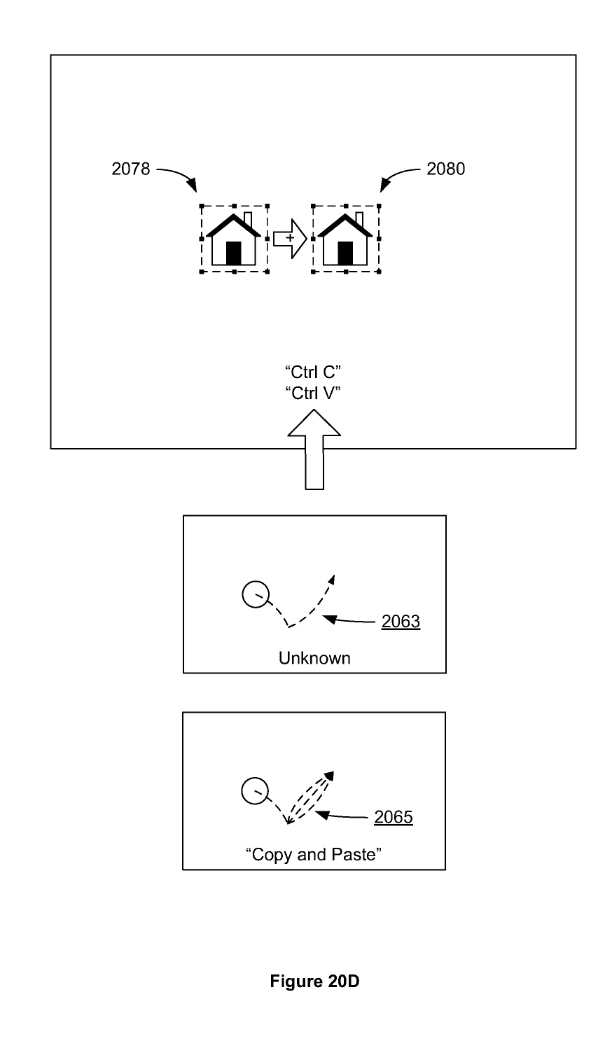

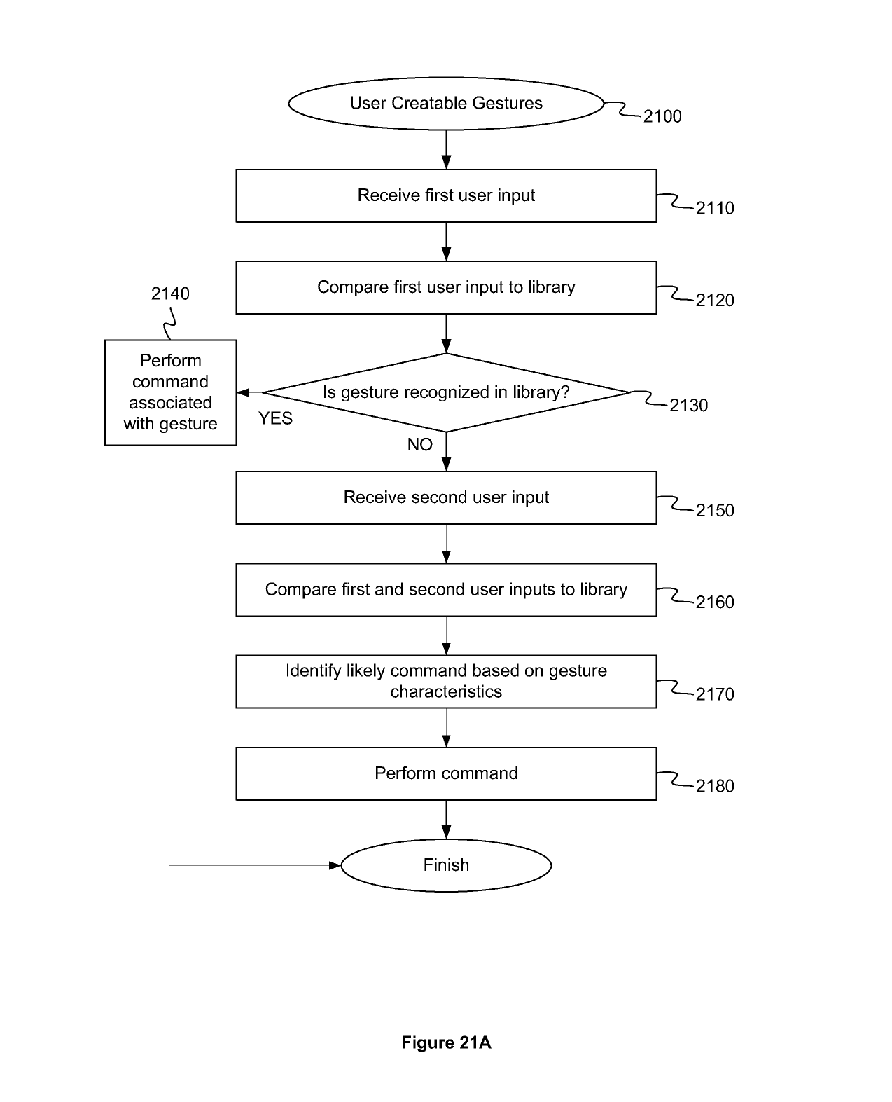

FIG. 20A is a flow diagram illustrating a gesture mapping method, according to an embodiment of the present invention. The method 2000 may be performed by processing logic that comprises hardware (e.g., circuitry, dedicated logic, programmable logic, microcode, etc.), software (e.g., instructions run on a processing device to perform hardware simulation), or a combination thereof. The processing logic is configured to provide a method for gesture mapping to associate a command with a received input gesture. In one embodiment, method 2000 may be performed by computing device 1700, as shown in FIG. 17. FIG. 20B is a diagram graphically illustrating the gesture mapping method 2000 of FIG. 20A.

Referring to FIG. 20A, at block 2010, method 2000 receives a first user input. In one embodiment, the first user input may include a gesture performed by a user on an input device, such as sensor array 1701. The gesture may be identified by a number of characteristics stored, for example, in an entry in gesture library 1730 corresponding to the gesture. For example, as illustrated in FIG. 20B, the gesture 2062 may include swiping one or more fingers in a “U” shaped motion across sensor array 1701. At block 2020, method 2000 compares the first user input to one or more entries in command library 1735. The received gesture may be associated with one or more commands stored, for example, in command library 1735. The commands may include operations to be performed by operating system 1712 or applications 1720 and 1722.

At block 2030, method 2000 determines if the gesture is recognized in the library 1735 and associated with a certain command. If so, at block 2040, method 2000 performs the command associated with the gesture. If at block 2030, method 2000 determines that the gesture is not already associated with a command, at block 2050, method 2000 may provide an interface 2072 with a list of one or more available commands. In one embodiment, the interface may be provided as a graphical user interface displayed on a display device, such as display device 1708. In the example illustrated in FIG. 20B, interface 2072 may include the following commands: (1) Delete; (2) Copy and Paste; (3) Rotate 90°; (4) Rotate 180′; and (5) Save.

At block 2060, method 2000 may receive a second user input indicating a desired command. In one embodiment, the interface may include all known commands or a selectively chosen subset of commands, from which the user may select a desired command. In another embodiment, the user may input the desired command into a designated field in the user interface or simply perform the command (e.g., via a keystroke or keyboard string). In one embodiment, for example, the second user input may include a keystroke 2074 including a number key (e.g., “3”) associated with one of the listed commands (e.g., Rotate 90°). The command may rotate a selected object 2066 by 90 degrees. At block 2070, method 2000 may associate the command indicated by the second user input 2074 at block 2060 with the gesture 2062 received as the first user input at block 2010. This may include, for example, linking an entry in gesture library 1730 with an entry in command library 1735 for the desired command, or otherwise associating the gesture 2062 and command.

FIG. 20C is a flow diagram illustrating a gesture mapping method, according to an embodiment of the present invention. The method 2005 may be performed by processing logic that comprises hardware (e.g., circuitry, dedicated logic, programmable logic, microcode, etc.), software (e.g., instructions run on a processing device to perform hardware simulation), or a combination thereof. The processing logic is configured to provide a method for gesture mapping to associate a command with a received input gesture. In one embodiment, method 2005 may be performed by computing device 1700, as shown in FIG. 17. FIG. 20D is a diagram graphically illustrating the gesture mapping method 2005 of FIG. 20C.

Referring to FIG. 20C, at block 2015, method 2005 receives a first user input. In one embodiment, the first user input may include a gesture performed by a user on an input device, such as sensor array 1701. The gesture may be identified by a number of characteristics stored, for example, in an entry in gesture library 1730 corresponding to the gesture. For example, as illustrated in FIG. 20D, gesture 2063 may include a swiping motion on the sensor array 1701 that is similar to a “check mark” gesture, but not exactly right. At block 2025, method 2005 compares the first user input to one or more entries in command library 1735. The received gesture 2063 may be associated with one or more commands stored, for example, in command library 1735. The commands may include operations to be performed by operating system 1712 or applications 1720 and 1722.

At block 2035, method 2005 determines if the gesture 2063 is recognized in the library 1735 and associated with a certain command. If so, at block 2045, method 2005 performs the command associated with the gesture 2063. If at block 2035, method 2005 determines that the gesture 2063 is not already associated with a command, at block 2055, method 2005 identifies a likely command from the library based on the gesture characteristics. Since the gesture 2063 was not exactly the same as of a recognized gesture, the gesture 2063 may not be recognized. If, however, the characteristics of the gesture 2063 are similar to the characteristics of a recognized gesture, or within in a certain defined tolerance of allowed characteristics (e.g., as illustrated by gesture 2065), method 2005 may make an “educated guess” (i.e. infer that the user intended to make a gesture with characteristics which are similar to the motion detected) based on the commands that are associated with other similar gestures as to what command is most likely to be associated with the gesture 2063 received as the first and second user inputs. At block 2065, method 2005 associates the command with the gestures and performs the newly associated command. In one embodiment, performing the command may include copying a selected object 2078 and pasting 2080 the copy into the displayed workspace or other location.

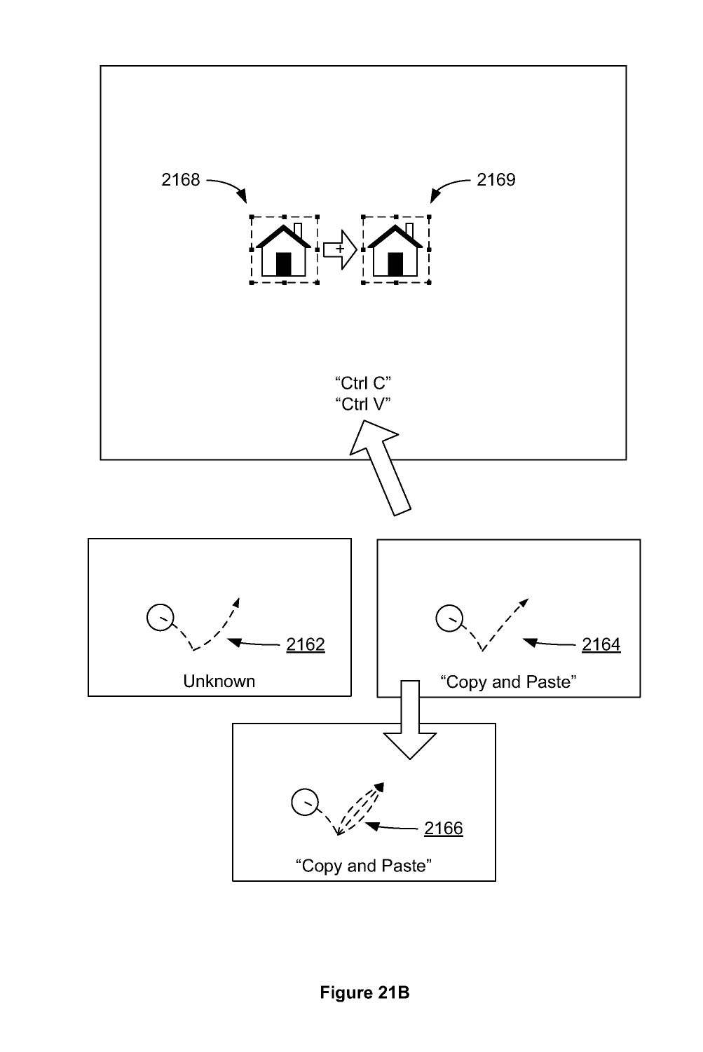

FIG. 21A is a flow diagram illustrating a method for user creatable gestures, according to an embodiment of the present invention. The method 2100 may be performed by processing logic that comprises hardware (e.g., circuitry, dedicated logic, programmable logic, microcode, etc.), software (e.g., instructions run on a processing device to perform hardware simulation), or a combination thereof. The processing logic is configured to provide method for implementing a new gesture and an associated command in a computing system. In one embodiment, method 2100 may be performed by computing device 1700, as shown in FIG. 17. FIG. 21B is a diagram graphically illustrating the gesture mapping method 2100 of FIG. 21A.

Referring to FIG. 21A, at block 2110, method 2100 receives a first user input. In one embodiment, the first user input may include a gesture performed by a user on an input device, such as sensor array 1701. The gesture may be identified by a number of characteristics stored, for example, in an entry in gesture library 1730 corresponding to the gesture. For example, as illustrated in FIG. 21B, gesture 2162 may include a swiping motion on the sensor array 1701 that is similar to a “check mark” gesture, but not exactly right. At block 2120, method 2100 compares the first user input to one or more entries in command library 1735. The received gesture 2162 may be associated with one or more commands stored, for example, in command library 1735. The commands may include operations to be performed by operating system 1712 or applications 1720 and 1722.

At block 2130, method 2100 determines if the gesture 2162 is recognized in the library 1735 and associated with a certain command. If so, at block 2140, method 2100 performs the command associated with the gesture 2162. If at block 2130, method 2100 determines that the gesture 2162 is not already associated with a command, at block 2150, method 2100 receives a second user input. Since the first gesture 2162 was not exactly the same as (or within a certain tolerance) of a recognized gesture, the gesture may be repeated 2164, as a second user input. In one embodiment, this second user input is the same gesture that was received as the first user input at block 2110. The second user input may be similarly received by sensor array 1701. For example, gesture 2164 may be a more accurate “check mark” gesture.

At block 2160, method 2100 compares the first and second user inputs to the command library 1735. In one embodiment, this may include identifying characteristics of the gestures 2162 and 2164, such as a number of contacts, the position of those contacts, relative and absolute motion of the contacts, or other characteristics and comparing the identified characteristics to characteristics of the commands stored in command library 1735. At block 2170, method 2100 identifies a likely command from the library based on the gesture characteristics. Method 2100 may make an “educated guess” based on the commands that are associated with other similar gestures as to what command is most likely to be associated with the gesture received as the first and second user inputs. At block 2180, method 2100 associates the command with the gestures and performs the newly associated command. In one embodiment, method 2100 may adjust the characteristics of the “Copy and Paste” command to include slight variations 2166 in the gestures associated with the command. This adjustment may allow either gesture 2162 or gesture 2164 to be recognized as the gesture 2166 associated with the command in the future. Performing the command may include copying a selected object 2168 and pasting 2169 the copy into the displayed workspace or other location.

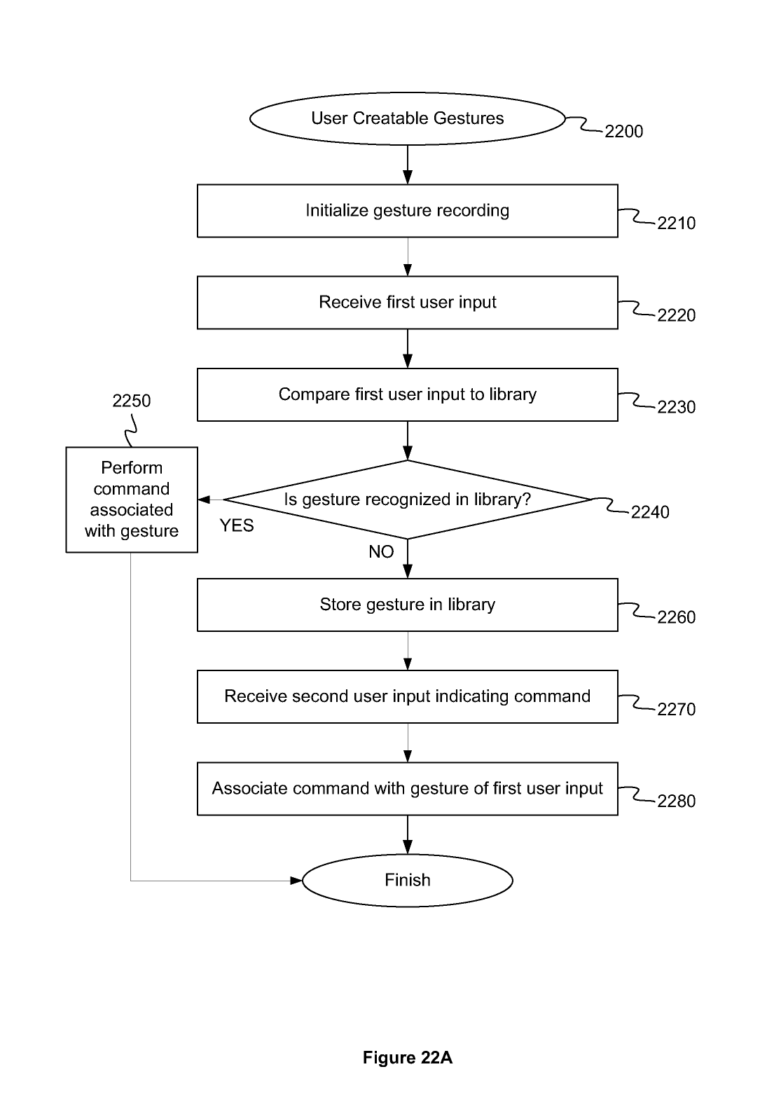

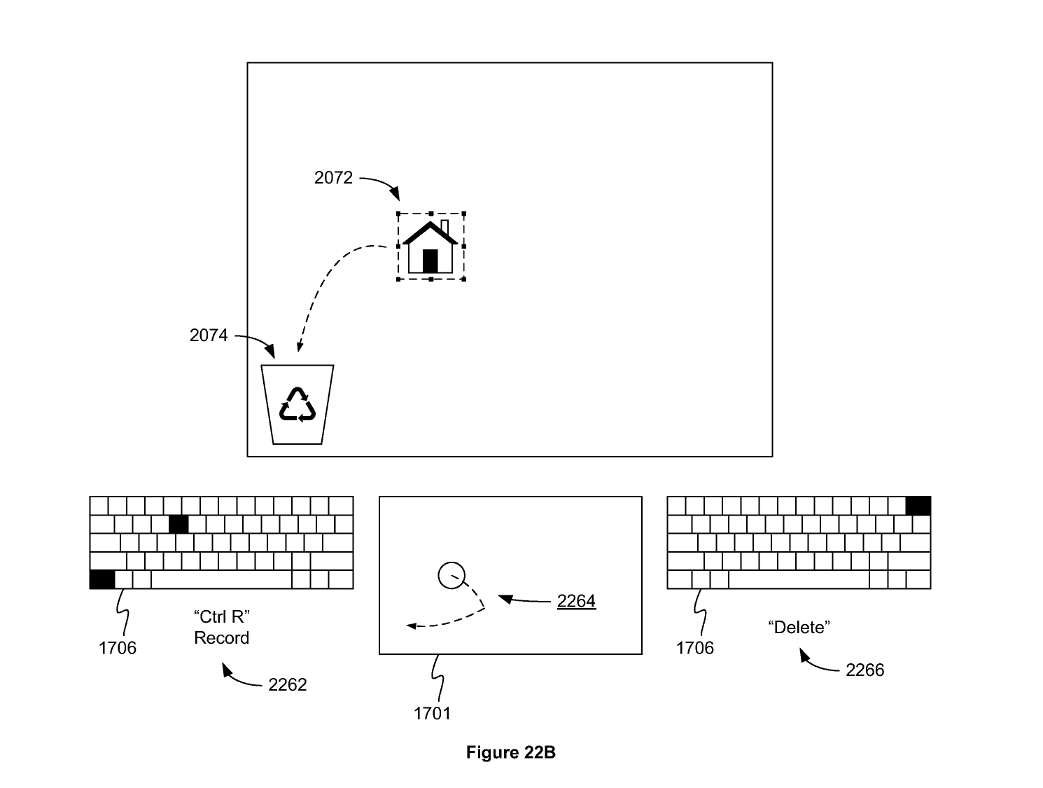

FIG. 22A is a flow diagram illustrating a method for user creatable gestures, according to an embodiment of the present invention. The method 2200 may be performed by processing logic that comprises hardware (e.g., circuitry, dedicated logic, programmable logic, microcode, etc.), software (e.g., instructions run on a processing device to perform hardware simulation), or a combination thereof. The processing logic is configured to provide method for implementing a new gesture and an associated command in a computing system. In one embodiment, method 2200 may be performed by computing device 1700, as shown in FIG. 17. FIG. 22B is a diagram graphically illustrating the gesture mapping method 2200 of FIG. 22A.

Referring to FIG. 22A, at block 2210, method 2200 initializes gesture recording. In one embodiment, the user may select (e.g., through a user interface displayed on display device 1708) gesture recording. Gesture recording may include receiving a user input on a touch pad, where the gesture is to be added to a gesture library 1730 storing saved gestures. For example, as illustrated in FIG. 22B, gesture recording may be initialized by a keyboard string 2262 entered on keyboard 1706. In one embodiment, the keyboard string is “CTRL R”. At block 2220, method 2200 receives a first user input. In one embodiment, the first user input may include a gesture performed by a user on an input device, such as sensor array 1701. The gesture may be identified by a number of characteristics stored, for example, in an entry in gesture library 1730 corresponding to the gesture. For example, as illustrated in FIG. 22B, the gesture 2264 performed on sensor array 1701 may include a “back and forth” swipe with one or more fingers. At block 2230, method 2200 compares the first user input to one or more entries in gesture library 1730 and command library 1735. The received gesture 2264 may be associated with one or more commands stored, for example, in command library 1735. The commands may include operations to be performed by operating system 1712 or applications 1720 and 1722.

At block 2240, method 2200 determines if the gesture 2264 is recognized in the gesture library 1730 and associated with a certain command in command library 1735. If so, at block 2250, method 2200 performs the command associated with the gesture 2264. If at block 2240, method 2200 determines that the gesture 2264 is not known in gesture library 1730 or already associated with a command, at block 2260, method 2200 stores the received gesture 2264 in the gesture library 1730. In one embodiment, method 2200 creates an entry for the received gesture 2264 in library 1730 and identifies the gesture 2264 according to one or more characteristics of the gesture, as described above.

At block 2270, method 2200 may receive a second user input indicating a desired command. In one embodiment, the interface may include all known commands or a selectively chosen subset of commands, from which the user may select a desired command. In another embodiment, the user may input the desired command into a designated field in the user interface or simply perform the command (e.g., via a keystroke or keyboard string). In one embodiment, for example, the user may enter a keystroke 2266 including the “Delete” key on keyboard 1706. At block 2280, method 2200 may associated the command indicated at block 2270 with the gesture 2266 received as the first user input at block 2220. This may include, for example, linking an entry in gesture library 1730 with an entry in command library 1735 for the desired command, or otherwise associating the gesture and command. In one embodiment, the “Delete” command may include placing a selected object 2072 in the Recycle Bin 2074 or Trash Can.

Although the present invention has been described with reference to specific example embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

In the foregoing specification, the invention has been described with reference to specific example embodiments thereof. The specification and drawings are, accordingly, to be regarded in an illustrative sense rather than a restrictive sense.

1. A system comprising:
a sensor configured to detect user inputs; and
a processor configured to:
receive a detected first user input from the sensor, the first user input comprising a gesture;
determine whether the gesture has an associated first command;
if the gesture has an associated first command, execute the associated first command;
receive a detected second user input, the second user input comprising an indication that the associated first command is incorrect;
reverse the execution of the first command to revert the system back to a state prior to the first command being executed;
receive a detected third user input from the sensor, the third user input indicative of a second command; and
assign the second command to the gesture based on the third user input.

2. (canceled)

3. The system of claim 1, further comprising a memory configured to store a library of commands, the library comprising the first command and the second command.

4. (canceled)

5. The system of claim 1, wherein the processor is further configured to indicate in the library that the associated first command should not be associated with the first user input.

6. The system of claim 3, wherein the processor is further configured to identify the first command based on a plurality of characteristics of the gesture.

7. The system of claim 1, wherein in order to assign the first command, the processor is further configured to:
generate a software-implemented keyboard; and
associate the first user input with a string input to the software-implemented keyboard.

8. A system comprising:
a sensing device configured to determine one or more characteristics of at least one of a plurality of user inputs, the at least one of the plurality of user inputs comprising a gesture; and
a processor configured to:
receive the determined one or more characteristics;
determine whether the determined one or more characteristics are associated with one of a plurality of known commands;
when the determined one or more characteristics are not associated with one of a plurality of known commands, identify at least one of the plurality of known commands to be associated with the at least one of the plurality of user inputs based on the determined one or more characteristics of the gesture, wherein to identify the at least one of the plurality of known commands, the processor is configured to determine whether the determined one or more characteristics of the gesture are within a defined tolerance of allowed characteristics of the at least one of the plurality of known commands; and
assign the at least one of the plurality of known commands to the at least one of the plurality of user inputs.

9. The system of claim 8, wherein the determined one or more characteristics uniquely identify the gesture performed by the at least one of the plurality of user inputs.

10. The system of claim 9, wherein the determined one or more characteristics is received during a gesture recording period.

11. The system of claim 9, further comprising a memory configured to store a library of the plurality of commands, wherein to identify the at least one of the plurality of known commands the processor is configured to identify the at least one of the plurality of known commands from the library based on the determined one or more characteristics.

12. The system of claim 8, further comprising:
a display device configured to display a graphical user interface, wherein the processor is further configured to present, in the graphical user interface, a list of available commands.

13. The system of claim 12, wherein to identify the at least one of the plurality of known commands the processor is configured to receive a second user input indicating a command from the list of available commands to be associated with the determined one of more characteristics.

14. The system of claim 11, wherein the processor is further configured to store the at least one of the plurality of known commands and the at least one of the plurality of user inputs in the library.

15. A method, comprising:
receiving a first user input detected by a sensor;
identifying one or more characteristics of the received first user input;
determining, by a processor, if the one or more characteristics matches a characteristic of a known gesture in a gesture library, the gesture library comprising a plurality of known gestures and one or more characteristics that identify each of the plurality of known gestures; and
if the one or more characteristics do not match a characteristic of a known gesture, generating a new gesture based on the one or more characteristics of the first user input, receiving a second user input, the second user input indicating a command, and associating the command indicated by the second user input with the new gesture associated with the first user input by linking an entry in the gesture library corresponding to the new gesture with an entry in a command library associated with the command.

16. (canceled)

17. The method of claim 15, further comprising:
determining a command associated with the first user input based on the identified one or more characteristics of the first user input.

18. The method of claim 15, wherein the identified one or more characteristics comprises one of a number of contacts with the sensor, a position of the contacts on the sensor, a relative motion of the contacts, and an absolute motion of the contacts on the sensor.

19. The method of claim 15, further comprising:
displaying on a display device, a graphical user interface including a list of available commands to be associated with the first user input.

20. The method of claim 15, wherein the first user input is received during a gesture recording period.

21. The system of claim 1, wherein the processor is further configured to:
in response to receiving the detected second user input from the sensor, reverse the execution of the associated first command.
